(19) United States
(12) Patent Application Publication
(10) Pub. No.: US 2006/0135804 A1
(43) Pub. Date: Jun. 22, 2006

(54) Tetradentate ligands and metal complexes thereof for asymmetric catalysis

(76) Inventor: Neil Warren Boaz, Kingsport, TN (US)

Correspondence Address: Michael J. Blake;Eastman Chemical Company, P.O. Box 511, Kingsport, TN, 37662-5075, US

(21) Appl. No.: 11/018,287

(22) Filed: Dec. 21, 2004

(51) Int. Cl. C07F 17/00

(52) U.S. Cl. 556/13

(57) ABSTRACT

This invention relates to novel, substantially enantiomerically pure tetradentate ligands comprised of two phosphines and two secondary amines. These species have been used as ligands for metal catalysts for asymmetric reactions and have demonstrated good enantioselectivity, in particular as ruthenium complexes for asymmetric hydrogenation. Also disclosed are methods for making the ligands, corresponding catalyst complexes, and processes employing the ligands and catalysts. The ligands may be described by the general formula 1:
R₂P-L¹-NH-L²-NH-L³-PR¹₂ 1

### FIELD OF THE INVENTION

This invention relates to novel tetradentate ligands comprised of two phosphines and two secondary amines. These species have been used as ligands for metal catalysis for asymmetric reactions and have demonstrated good enantioselectivity, in particular as ruthenium complexes for asymmetric hydrogenation.

### BACKGROUND OF THE INVENTION

Asymmetric catalysis is the most efficient method for generating products with high enantiomeric purity, as the asymmetry of the catalyst is multiplied many times over in generating the chiral product. These chiral products have found numerous applications, such as building blocks for single enantiomer pharmaceuticals and in some agrochemicals. The asymmetric catalysts employed can be enzymatic or synthetic in nature. The latter types of catalyst have much greater promise than the former because of a much greater latitude in applicable reaction types. Synthetic asymmetric catalysts are usually composed of a metal reaction center surrounded by one or more organic ligands. The ligands usually are generated in high enantiomeric purity, and are the agents inducing the asymmetry. These ligands are, in general, difficult to make and therefore expensive.

The asymmetric reduction of ketones to afford chiral alcohols is a key transformation having numerous applications in the pharmaceutical, agrochemical, and flavors and fragrances areas. A number of technologies are available for this type of reduction, including chiral oxazaborolidine-catalyzed borane reductions (Itsuno, S. in Comprehensive Asymmetric Catalysis, Volume I, Jacobsen, E. N.; Pfaltz, A.; Yamamoto, H, eds, Springer-Verlag, N.Y., pp. 289-315) and rhodium- and ruthenium-catalyzed transfer hydrogenations (Ohkuma et al. in Comprehensive Asymmetric Catalysis, Volume I, Jacobsen, E. N.; Pfaltz, A.; Yamamoto, H, eds, Springer-Verlag, N.Y., pp. 227-246). The foregoing technologies, however, generally use relatively large amounts of catalyst (>1 mol %) and, for the latter reaction, require dilute conditions and are therefore not particularly efficient. Of particular note are the recent reports of catalysts comprised of a mixture of a chiral bis-phosphine and a chiral diamine ligated to ruthenium, which are reported to afford high enantioselectivity for the asymmetric hydrogenation of ketones at low catalyst loadings (Ohkuma, et al, J. Am. Chem. Soc, 1995, 117, 2675-2676; Doucet, et al, Angew. Chem. int. Ed. 1998, 37, 1703-1707; Ohkuma, et al, Organic Lett. 2000, 2, 1749-1751). A particular drawback of these systems is the potential for formation of mixed complexes comprising two bis-phosphines or two bis-amines surrounding the metal. These species may afford results that are destructive compared to that of the mixed complexes. There has been a report of a ruthenium complex of a ligand system comprising two achiral phosphines linked through a chiral diamine for ketone reduction (Gao, et al, Organometallics 1996, 15, 1087-1089). This system is effective for the transfer hydrogenation of ketones but has not been reported for direct hydrogenation reactions.

As described by Richards et al. in Tetrahedron: Asymmetry 1998, 9, 2377-2407, asymmetric ferrocene derivatives have found great utility as ligands for asymmetric catalysis in reactions as varied as asymmetric hydrogenations, asymmetric Aldol reactions, asymmetric organometallic additions, and asymmetric hydrosilations. These ferrocene species usually are bidentate in nature, using a variety of ligating species.

### BRIEF SUMMARY OF THE INVENTION

We have now found a series of novel, substantially enantiomerically pure, tetradentate ligands wherein the ligating groups comprise two phosphines linked by chiral backbones to two secondary amines. These ligands may be described by the general formula 1:
R₂P-L¹-NH-L²-NH-L³-PR¹₂
In the foregoing formula 1, R and R¹ are, independently, branched- or straight-chain C₁-C₂₀ alkyl, C₃-C₈ cycloalkyl, C₆-C₂₀ carbocyclic aryl, or a C₄-C₂₀ heteroaryl having from one to three heteroatoms selected from sulfur, nitrogen, and oxygen; L¹, L², and L³ may be the same or different, and are divalent radicals selected from branched- or straight-chain C₁-C₂₀ alkyl, C₃-C₈ cycloalkyl, C₆-C₂₀ carbocyclic aryl, a C₄-C₂₀ heteroaryl having from one to three heteroatoms selected from sulfur, nitrogen, and oxygen, or metallocenylalkyl and wherein L¹, L³ and, optionally, L² are substantially enantiomerically pure. The foregoing moieties for each of R and R¹, and each of L¹ through L³ may be unsubstituted or substituted with groups described below.

Also described herein is a method for making the novel, substantially enantiomerically pure, tetradentate ligands in good yields and purity. Further, methods for making metal catalyst complexes and processes employing the ligands and the metal complexes are described herein.

### DETAILED DESCRIPTION

We have discovered a series of novel substantially enantiomerically pure tetradentate ligands wherein the ligating groups comprise two phosphines linked by chiral backbones to two secondary amines. These ligands are described by the general formula 1:
R₂P-L¹-NH-L²-NH-L³-PR¹₂ 1
wherein R and R¹ are, independently, branched- or straight-chain C₁-C₂₀ alkyl, C₃-C₈ cycloalkyl, C₆-C₂₀ carbocyclic aryl, or a C₄-C₂₀ heteroaryl having from one to three heteroatoms selected from sulfur, nitrogen, and oxygen; L¹, L², and L³ may be the same or different, and are divalent radicals selected from branched- or straight-chain C₁-C₂₀ alkyl, C₃-C₈ cycloalkyl, C₆-C₂₀ carbocyclic aryl, a C₄-C₂₀ heteroaryl having from one to three heteroatoms selected from sulfur, nitrogen, and oxygen, or metallocenylalkyl and wherein L¹, L³ and, optionally, L² are substantially enantiomerically pure. The foregoing moieties for each of R and R¹, and each of L¹ through L³ may be unsubstituted or substituted with one or more groups described below. As used herein, the phrase “enantiomerically enriched” indicates that one enantiomer is present in excess of the other, the phrase “substantially enantiomerically pure” connotes a degree of excess of 90% or greater and “enantiomeric excess” (or ee) indicates the percent of the major enantiomer less the percent of the minor enantiomer.

Specific examples of the tetradentate ligands of the present invention include those wherein R and R¹ are identical and L¹ and L³ are identical. For example, R₂P-L¹-NH— and R¹₂P-L³-NH— may be identical species denoted by structures 2 or 3 (the enantiomer of 2) as follows: 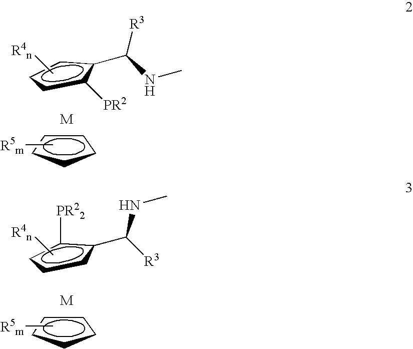
wherein

each R² is either of R or R¹ described above; R³, R⁴, and R⁵ are each independently selected from hydrogen, branched- or straight-chain C₁-C₂₀ alkyl, C₃-C₈ cycloalkyl, C₆-C₂₀ carbocyclic aryl, or C₄-C₂₀ heteroaryl having one to three heteroatoms selected from sulfur, nitrogen, and oxygen;

n is 0 to 3;

m is 0 to 5; and

M is selected from the metals of Groups IVB, VB, VIB, VIIB and VIII.

L² is a C₁-C₂₀ alkylene, C₃-C₈ cycloalkylene, or 1,1′-biaryl-2,2′-diyl. The foregoing values for L² may be achiral, racemic, enantiomerically enriched, or substantially enantiomerically pure and may be unsubstituted or may be substituted with one or more groups below.

As noted above, the values for each of R₂P-L¹-NH— and R¹₂P-L³-NH— need not be identical. Thus, for example, when general structure 2 or 3 represents each of R₂P-L¹-NH— and R¹₂P-L³-NH—, each of the individual groups R² through R⁵ for each of general formula 2 or 3 may be chosen independently. For example, while general structure 2 may represent both R₂-L¹-NH— and R¹₂P-L³-NH—, the individual R or R¹ group on each end of structure I (e.g., R² in structure 2) may be chosen independently. Likewise, “L¹” may be represented by a first general formula 2 (or 3) and “L³” may be represented by a second general formula 2 (or 3); the R² through R⁵ groups on the first formula 2 (or 3) may be chosen independently from those chosen for the second general formula 2 (or 3).

The alkyl groups that may represent each of R, R¹, R², R³, R⁴, and R⁵ may be straight- or branched-chain aliphatic hydrocarbon radicals containing from one up to about 20 carbon atoms and may be substituted, for example, with one to three groups selected from C₁-C₆-alkoxy, cyano, C₂-C₆-alkoxycarbonyl, C₂-C₆-alkanoyloxy, hydroxy, aryl and halogen. The terms “C₁-C₆-alkoxy”, “C₂-C₆-alkoxycarbonyl”, and “C₂-C₆-alkanoyloxy” are used to denote radicals corresponding to the structures —OR⁶, —CO₂ R⁶, and —OCOR⁶, respectively, wherein R⁶ is C₁-C₆-alkyl or substituted C₁-C₆-alkyl.

The term “C₃-C₈-cycloalkyl” is used to denote a saturated, carbocyclic hydrocarbon radical having three to eight carbon atoms. The “C₆-C₂₀ carbocyclic aryl” groups that each of R, R¹, R², R³, R⁴, and R⁵ may represent may include phenyl, naphthyl, or anthracenyl. Each of the cycloalkyl and carbocyclic aryl groups may be substituted with one to three substituents selected from C₁-C₆-alkyl, C₆-C₁₀ aryl, C₁-C₆-alkoxy, halogen, carboxy, cyano, C₁-C₆-alkanoyloxy, C₁-C₆-alkylthio, C₁-C₆-alkylsulfonyl, trifluoromethyl, hydroxy, C₂-C₆-alkoxycarbonyl, C₂-C₆-alkanoylamino, —O—R⁷, —S—R⁷_{,} —SO₂—R⁷, —NHSO₂R⁷ and —NHCO₂R⁷, wherein R⁷ is phenyl, naphthyl, or phenyl or naphthly substituted with one to three groups selected from C₁-C₆-alkyl, C₆-C₁₀ aryl, C₁-C₆-alkoxy and halogen.

The heteroaryl radicals contain from four to twenty carbon atoms and from one to three heteroatoms selected from sulfur, nitrogen and oxgen. Specific examples include 5- or 6-membered aromatic rings containing one to three heteroatoms selected from oxygen, sulfur and nitrogen. Examples of such heteroaryl groups are thienyl, furyl, pyrrolyl, imidazolyl, pyrazolyl, thiazolyl, isothiazolyl, oxazolyl, isoxazolyl, triazolyl, thiadiazolyl, oxadiazolyl, tetrazolyl, pyridyl, pyrimidyl, benzoxazolyl, benzothiazolyl, benzimidazolyl, indolyl and the like. The heteroaryl radicals may be substituted, for example, with up to three groups such as C₁-C₆-alkyl, C₁-C₆-alkoxy, halogen, C₁-C₆-alkylthio, aryl, arylthio, aryloxy, C₂-C₆-alkoxycarbonyl and C₂-C₆-alkanoylamino. The heteroaryl radicals also may be substituted with a fused ring system, e.g., a benzo or naphtho residue, which may be unsubstituted or substituted, for example, with up to three of the groups set forth in the preceding sentence. The term “halogen” includes fluorine, chlorine, bromine, and iodine.

The skilled artisan will understand that each of the references herein to groups or moieties having a stated range of carbon atoms, such as “C₁-C₆-alkyl,” includes not only the C₁ group (methyl) and C₆ group (hexyl) end points, but also each of the corresponding individual C₂, C₃, C₄ and C₅ groups. In addition, it will be understood that each of the individual points within a stated range of carbon atoms may be further combined to describe subranges that are inherently within the stated overall range. For example, the term “C₁-C₆-alkyl” includes not only the individual moieties C₁ through C₆, but also contemplates subranges such as “C₂-C₅-alkyl.”

The compounds of the invention that presently are preferred have formulas 2 or 3 wherein R² is aryl, most preferably phenyl; R³ is hydrogen or C₁ to C₆ alkyl (such as methyl); R⁴ and R⁵ are hydrogen; L² is 1,2-ethanediyl, 1,3-propanediyl, 1,4-butanediyl, substantially enantiomerically pure 1,2-diphenyl-1,2-ethanediyl, substantially enantiomerically pure trans-1,2-cyclohexanediyl, or substantially enantiomerically pure 1,1′-binaphth-2,2′-diyl; and M is iron, ruthenium, or osmium, most preferably iron.

When the diamino portion represented by —NH-L²-NH— is achiral, it can be any diamino species having two NH groups, and are preferably alkane species with amino groups at each terminus such as ethylenediamino, 1,3-propanediamino, 1,4-butanediamino, and the like. When the diamino group represented by —NH-L²-NH— is chiral, it can be any chiral diamino species possessing two NH groups with one or more chiral centers. The chiral diamino groups are most preferably substantially enantiomerically pure C₂-symmetrical diamino groups such as 1,2-diphenyl-1,2-ethanediamino, trans-1,2-cyclohexanediamino, and 1,1′-binaphth-2,2′-yl diamino.

As stated above, certain embodiments of the compounds of our invention are those containing two substantially enantiomerically pure phosphinometallocenylalkyl groups linked together by a chiral or achiral diamine. The metallocene-based embodiments of our ligands are readily modifiable by varying R² according to the choice of the phosphine used, R³ according to the backbone used, and L² according to the diamine used, and thus allows simple modification of the reactivity and selectivity of the catalyst prepared from such ligands.

We also provide novel processes for preparing compounds of formula 1 in which the two phosphine moieties are linked by the diamine. Thus, for example, the present invention includes a process for preparing a substantially enantiomerically pure compound having formula 4:

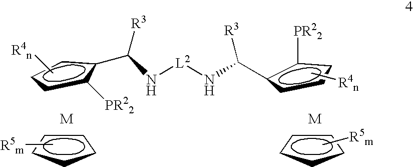

which comprises the steps of:

(1) contacting a dialkyl amine having formula 5:

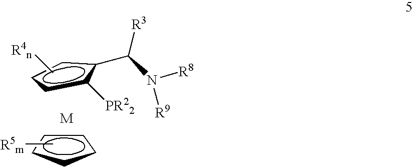

with a carboxylic anhydride having the formula (R¹⁰CO)₂O to obtain an ester compound having formula 6:

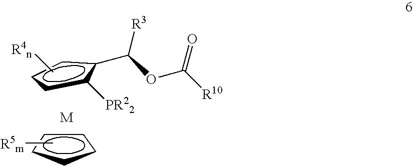

(2) contacting the ester produced in step (1) with a diamine having the formula H₂N-L²-NH₂ to obtain phosphine-diamine 7:

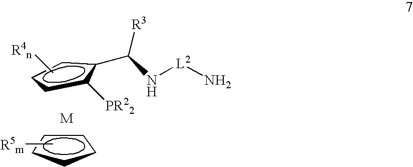

(3) contacting the phosphine-diamine produced in step (2) with an ester such as that produced in step (1) to afford diphosphine-diamine 4

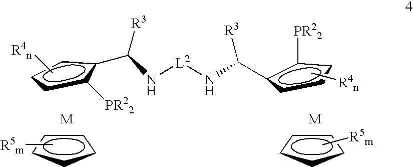

wherein each R², R³, R⁴, R⁵, n, m, L² and M are defined hereinabove, R⁸ and R⁹ are independently selected from branched- or straight-chain C₁-C₂₀ alkyl, C₃-C₈ cycloalkyl, C₆-C₂₀ carbocyclic aryl, or C₄-C₂₀ heteroaryl having from one to three heteroatoms selected from sulfur, nitrogen, and oxygen, and R¹⁰ is a C₁ to C₄ alkyl radical. The groups representing each of R⁸ and R⁹ may be unsubstituted or substituted with, for example, one or more groups as set forth above in relation to substituents for each of R², R³, R⁴ and R⁵.

The compounds of formula 8:

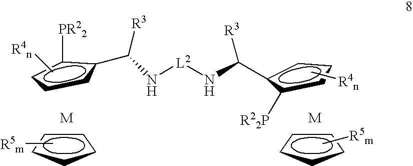

may be prepared when a dialkylamine having formula 9:

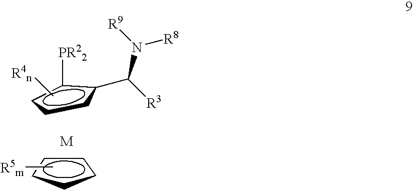

is used as the starting material affording intermediates 10 and 11 analogous to 6 and 7, respectively.

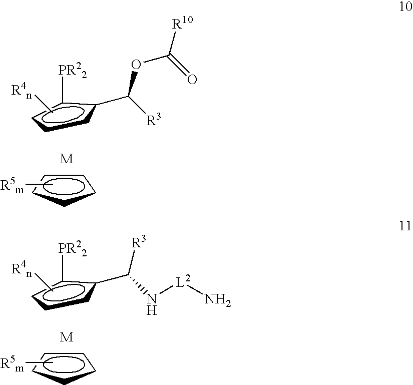

Dialkylamine reactant compounds 5 (or 9) can be prepared in high enantiomeric purity by several known methods. For example, precursor 12 having the formula: 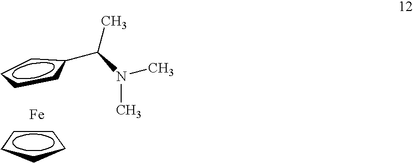
can be prepared in high enantiomeric purity using the procedures described by Marquarding et al., J. Am. Chem. Soc. 1970, 92, 5389-5393; Armstrong et al., Anal. Chem. 1985, 57, 481-484; and Boaz, N. W. Tetrahedron Letters 1989, 30, 2061-2064. Precursor 12 can then be converted by known procedures to dialkylamine reactant 5, e.g., using the procedures described in Hayashi, T. et al. Bull Chem. Soc. Jpn. 1980, 53, 1130-1151; and the references mentioned in the preceding sentence. The enantiomeric species 9 can be prepared in a like manner.

In the first step of the process, dialkylamine reactant compound 5 (or 9) is contacted with a carboxylic anhydride. The amount of anhydride used may be about 1 to about 100 moles, preferably about 2 to about 10 moles, per mole of dialkylamine reactant 5 (or 9). Although the carboxylic anhydride may contain up to about 10 carbon atoms, acetic anhydride is preferred. That is, R¹⁰ is a C₁ to C₄ alkyl, and R¹⁰ is preferably a C₁ group. The first step of the process may be carried out at a temperature between about 20° C. and the boiling point of the anhydride, preferably about 80° C. to about 120° C. While an inert solvent may be used in step (1), the carboxylic anhydride may function as both solvent and reactant. At the completion of the first step, the ester intermediate may be isolated for use in the second step by conventional procedures known to those skilled in the art. For example, the product may be crystallized or isolated by removing the carboxylic anhydride and any extraneous solvent present, such as by decanting or distillation or both.

In the second step of the process, the ester intermediate obtained from step (1) is contacted with a diamine having the formula H₂N-L²-NH₂ in the presence of a solvent. The solvent may be water, a C₁ to C₄ alkanol such as methanol, ethanol, isopropanol, or n-butanol, a dipolar aprotic solvent such as acetonitrile, dimethylformamide, or dimethylsulfoxide, an aromatic hydrocarbon such as benzene, toluene, or xylene, a halocarbon solvents such as dichloromethane, tetrachloroethylene, or chlorobenzene or a mixture of any of the foregoing. Preferred solvents include, but are not limited to, a mixture of methanol and toluene, a mixture of water, 2-propanol, and toluene, or dimethylformamide. The second step may be carried out at a temperature between about 20° C. and the boiling point of the solvent, preferably about 25° C. to about 50° C.

In the foregoing description of a process to make compound 4, the reaction in step (2) is conducted in a way to allow for isolation of intermediate 7 (or, in the case of starting material 9, intermediate 11). For example, using an excess of diamine in step (2) predominantly results in the mono-substituted diamine exemplified by intermediate 7. Thus, the mole ratio in step (2) of the diamine:ester intermediate 6 (or 10) typically is in the range of about 0.8:1 to 10:1, preferably 0.8:1 to 5:1.

Allowing for the isolation of intermediate 7 (or, in the case of starting material 9, intermediate 11), in turn allows one to select the ester used in step (3) according to the characterics desired in the end product. In the above example, the ester of 5 (compound 6) is used in both step (1) and step (3) to provide compound 4; one of skill in the art will appreciate, however, that an ester of 9 (compound 10) may be used in step (3). Likewise, an ester of 5 (compound 6) may be used in step (3) when ester of 9 (compound 10) is produced in step (1). Further, as stated above, when the ester of 5 (compound 6) is used in both steps (1) and (3) (as a first ester 6 and a second ester 6, respectively), each of the variables on compound 6 used in step (3) may be chosen differently from those employed in step (1) (e.g., each R², R³, R⁴, and R⁵ on the second ester 6 are selected independently of those chosen for the first ester 6); the same applies when compound 10 is employed in both steps (1) and (3).

In addition, the second step of the reaction may optionally be carried out in the presence of an acid acceptor. Suitable examples include a tertiary amine such as trialkylamines containing a total of 3 to 15 carbon atoms such as triethylamine, tripropylamine, and diisopropylethylamine, pyridine, substituted pyridines and the like. The amount of acid acceptor used normally is from 0 up to about 10 moles of acid acceptor per mole of diamine reactant.

In the third step of the above process, the phosphine-diamine intermediate obtained from step (2) is contacted with an ester of formula 6 (or 10) in the presence of a solvent, which may be chosen from among those noted above as suitable for use in the second step. The third step may be carried out at a temperature between about 20° C. and the boiling point of the solvent, preferably about 25° C. to about 50° C. The mole ratio of the phosphine-diamine:ester intermediate 6 (or 10) in the third step typically is in the range of about 1:1 to about 1:5. As with the second step, this reaction may optionally be carried out in the presence of an acid acceptor such as those listed above as being suitable for use in the second step. The amount of acid acceptor used normally is from 0 up to about 10 moles of acid acceptor per mole of diamine reactant.

A further embodiment of the processes of the present invention involves directly producing compounds having formula 1 in a two step process. Thus, for example, the present invention relates to a process for preparing a substantially enantiomerically compound having formula 4:

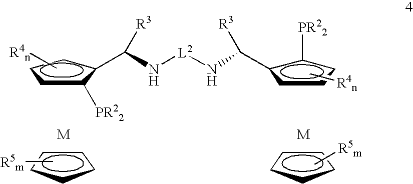

which comprises the steps of:

(1) contacting a dialkyl amine having formula 5:

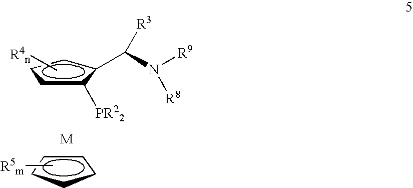

with a carboxylic anhydride having the formula (R¹⁰CO)₂O to obtain an ester compound having formula 6:

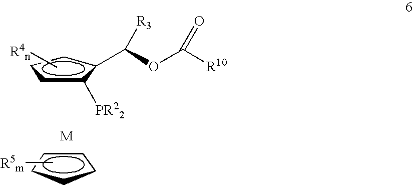

and

(2) contacting the ester produced in step (1) with a diamine having the formula H₂N-L²-NH₂ to obtain in simple fashion the diphosphine-diamine 4:

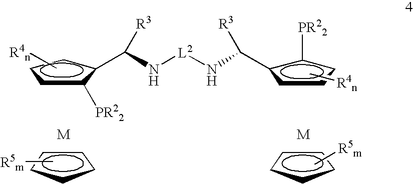

wherein R², R³, R⁴, R⁵, R⁸, R⁹, R¹⁰, n, m, L² and M are defined above.

Likewise, the compounds of formula 8:

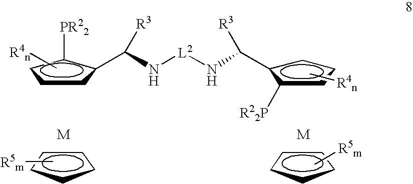

may be prepared when dialkylamine having formula 9:

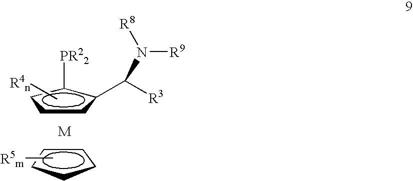

is used as the starting material affording intermediate 10 (which is analogous to 6).

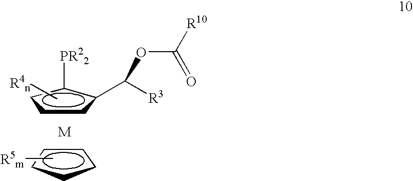

In the first step of the process, dialkylamine reactant compound 5 (or 9) is contacted with a carboxylic anhydride. The amount of anhydride used may be about 1 to about 100 moles, preferably about 2 to about 10 moles, per mole of dialkylamine reactant 5 (or 9). The first step of the process may be carried out at a temperature between about 20° C. and the boiling point of the anhydride, preferably about 80° C. to about 120° C. While an inert solvent may be used in step (1), the carboxylic anhydride may function as both solvent and reactant. At the completion of the first step, the ester intermediate may be isolated for use in the second step by conventional procedures known to those skilled in the art. For example, the product may be crystallized or isolated by removing the carboxylic anhydride and any extraneous solvent present, such as by decanting or distillation or both.

In the second step of the process, the ester intermediate obtained from step (1) is contacted with a diamine having the formula H₂N-L²-NH₂ in the presence of a solvent. The solvent may be water, a C₁ to C₄ alkanol such as methanol, ethanol, n-propanol, isopropanol, or n-butanol, a dipolar aprotic solvent such as acetonitrile, dimethylformamide, or dimethylsulfoxide, an aromatic hydrocarbon such as benzene, toluene, or xylene, a halocarbon solvents such as dichloromethane, tetrachloroethylene, or chlorobenzene or a mixture of any of the foregoing. Preferred solvents include, but are not limited to, a mixture of methanol and toluene, a mixture of water, isopropanol, and toluene, or dimethylformamide. The second step may be carried out at a temperature between about 20° C. and the boiling point of the solvent, preferably about 25° C. to about 50° C.

In the foregoing two-step process to produce compounds of formula 1, the same ester is attached to both amine moieties of the diamine having the formula H₂N-L²-NH₂. This may be done in a simple and direct fashion by controlling the reactant ratio. Thus, the mole ratio of the diamine:ester intermediate 6 (or 10) typically is in the range of about 1:2 to about 1:5. When the process is operated in this manner, it is not necessary to isolate a phosphine-diamine intermediate for further reaction with an ester. In this two-step process, one may therefore easily and simply produce 4, in the case of starting material 5 and ester 6 (or, compound 8 in the case of starting material 9 and ester 10).

In addition, the second step of the reaction may optionally be carried out in the presence of an acid acceptor. Suitable examples include a tertiary amine such as trialkylamines containing a total of 3 to 15 carbon atoms such as triethylamine, tripropylamine, and diisopropylethylamine, pyridine, substituted pyridines and the like. The amount of acid acceptor used normally is from 0 up to about 10 moles of acid acceptor per mole of diamine reactant.

Also included within the scope of the present invention are catalytically-active compounds comprising one or more substantially enantiomerically pure, diphosphinodiamine compounds 1 in complex association with one or more Group VIb or Group VIII metals, preferably rhodium, iridium, or ruthenium, most preferably ruthenium. These complexes can be prepared in situ, but it is often preferable to prepare and isolate them. The catalyst complexes generally may be prepared by mixing the ligand and a metal precursor in an inert solvent followed by isolation of the complex by standard procedures such as solvent distillation or crystallization.

For example, ruthenium complexes of 4 may be prepared by mixing 4 with a suitable ruthenium precursor, such as arenerutheniumdichloride dimer. Examples of such precursors include benzenerutheniumdichloride dimer and p-cymeneruthenium dichloride dimer. The molar ratio of ligand to metal atoms in the metal precursor (e.g., areneruthenium dichloride dimer) is generally about 0.5:1 to about 2.5:1, respectively, and preferably is about 0.8:1 to about 1.5:1. Inert solvents used to prepare such a complex include aromatic hydrocarbons such as benzene, toluene, xylenes, and the like, lower alcohols such as methanol, ethanol, n-propanol, or isopropanol, or polar aprotic solvents such as dimethyl formamide, acetonitrile, or dimethyl sulfoxide. Preferable solvents include toluene, isopropanol or dimethyl formamide. The reactions can be performed between ambient temperature and the boiling point of the solvent, most preferably between about 50° C. and about 120° C.

There are a large number of possible reactions of a wide variety of substrates using catalysts based on compound 1, including but not limited to asymmetric hydrogenations, asymmetric reductions, asymmetric hydroborations, asymmetric olefin isomerizations, asymmetric hydrosilations, asymmetric allylations, and asymmetric organometallic additions. A further embodiment of the present invention is an asymmetric hydrogenation reaction using a metal complex of compound 1. Thus, the present invention includes a process for the asymmetric hydrogenation of a suitable carbonyl compound which comprises contacting the carbonyl compound with hydrogen in the presence of a catalyst complex comprising ligand 1 in complex association with a metal. The reaction results in the formation of a chiral secondary alcohol, which is generally obtained in moderate to high enantiomeric excess.

For an asymmetric hydrogenation reaction, the metal complexed can be chosen from the group consisting of rhodium, ruthenium, and iridium, and is most preferably ruthenium. The ligand-metal complex can be prepared and used in situ, but it is often preferable to prepare and isolate the complex as described above. The amount of complex can vary between about 0.00005 and about 0.5 equivalents based on the reactant carbonyl compound, with more complex usually providing faster reaction rates. The atmosphere is generally hydrogen or hydrogen mixed with other inert gases. The reaction can be run between about 1 and about 2000 psig hydrogen, and is preferably run between about 50 and about 500 psig. The reaction is run at a temperature which affords a reasonable rate of conversion, which can be as low as about −50° C., but is usually between ambient temperature and the boiling point (or apparent boiling point at elevated pressure) of the lowest boiling component of the reaction mixture. The asymmetric hydrogenation is usually performed in the presence of a suitable solvent. A solvent for use herein includes: lower alcohols such as methanol, ethanol, or isopropanol; aliphatic hydrocarbons such as hexane, heptane, octane and the like; aromatic hydrocarbons such as toluene, xylenes and the like; cyclic or acyclic ethers such as tert-butyl methyl ether, diisopropyl ether, tetrahydrofuran and the like; halogenated aliphatic or aromatic hydrocarbons such as dichloromethane, tetrachloroethylene, chloroform, chlorobenzene and the like; or polar aprotic solvents such as dimethylformamide, dimethyl sulfoxide and the like. The most preferred solvent is isopropanol.

The asymmetric hydrogenations are also run in the presence of a Bronsted base chosen from alkali metal hydroxides such as sodium hydroxide or potassium hydroxide or metal alkoxides such as sodium methoxide, potassium methoxide, sodium tert-butoxide, potassium tert-butoxide and the like. The preferred base is potassium tert-butoxide. The amount of base is generally between about 1 and about 100 equivalents based on the metal complex, preferably between about 10 and about 50 equivalents.

This invention can be further illustrated by the following examples of preferred embodiments thereof, although it will be understood that these examples are included merely for purposes of illustration and are not intended to limit the scope of the invention unless otherwise specifically indicated.

### EXAMPLES

### Example 1

### Preparation of (S)-1-[(R)-2-(Diphenylphosphino)ferrocenyl]ethyl acetate (S,R-10a)

(S)-N,N-Dimethyl-1-[(R)-2-(diphenylphosphino)ferrocenyl]ethylamine (S,R-9a, R³═R⁸═R⁹=methyl, R²=phenyl-Ph, R⁴═R⁵═H, M=Fe))(5.0 g; 11.3 mmol) was combined with acetic anhydride (5.0 mL; 53 mmol; 4.7 equivalents). The flask was evacuated and filled with nitrogen ten times and then heated to 90° C. for 4 hours, at which point thin layer chromatography (tlc) analysis indicated no 9a present. The residual acetic anhydride was evaporated at reduced pressure, dissolved in ethyl acetate and concentrated two times to afford a crude solid. The crude product was dissolved in ethyl acetate (4 mL), diluted with heptane (20 mL) and cooled to 4° C. The resulting crystals were filtered, washed with heptane, and dried under nitrogen to afford 4.21 g (82%) of S,R-10a.

¹H NMR (CDCl₃) δ 7.6-7.1 (m, 10 H); 6.22 (m,1H); 4.573 (br s, 1H); 4.36 (m, 1H); 4.049 (s, 5H); 3.804 (m, 1H); 1.632 (d, J=6.32 Hz, 3H); 1.170 (s, 3H).

The enantiomer R,S-6a was prepared in a similar fashion from R,S-5a.

### Example 2

### Preparation of N,N′-Bis[(S)-1-[(R)-2-Diphenylphosphino)ferrocenyl]ethyl ethylenediamine (S-8a)

Ester S,R-10a (1.0 g; 2.19 mmol; 2.1 equiv) was combined with 5 mL of isopropanol and 2 mL of water. Ethylenediamine (69 mL; 1.04 mmol) was added and the mixture was heated to 50° C. Toluene (1 mL) was added and the reaction was heated overnight at 50° C., at which time a small amount of 10a was still present according to tic analysis. Triethylamine (0.30 mL) was added and the mixture was heated at 50° C. for 4 h to completely consume 10a according to tic analysis. The volatiles were distilled at reduced pressure and the residue was partitioned between 1 N sodium hydroxide and ethyl acetate. The layers were separated and the aqueous layer was extracted with additional ethyl acetate. The combined organic solution was extracted with 10% aqueous citric acid (4×5 mL). The aqueous extracts were made basic with 2 N sodium hydroxide (20 mL) and extracted three times with ethyl acetate. The combined extracts were dried (magnesium sulfate) and concentrated to afford 0.71 g. The crude product was filtered through a pad of flash silica gel and eluted with 1:1 ethyl acetate:heptane to remove impurities, and then with 5% triethylamine in ethyl acetate to afford 0.18 g (20%) of S-8a.

¹H NMR (CDCl₃) δ 7.6-7.1 (m, 20 H); 4.44 (m, 2H); 4.28 (m, 2H); 3.972 (s, 10H); 3.88 (m, 2H); 3.78 (m, 2H); 1.9-1.8 (m, 4H); 1.4-1.3 (m, 6H).

FDMS: m/e 852.14 (M⁺).

### Example 3

### Preparation of N,N′-Bis[(S)-1-[(R)-2-Diphenylphosphino)ferrocenyl]ethyl (R,R)-1,2-cyclohexyldiamine (S,R-8b)

Ester S,R-10a (1.0 g; 2.19 mmol) was combined with R,R-1,2-diaminocyclohexane (1.25 g; 10.95 mmol; 5 equiv) in 5 mL of isopropanol, 2 mL of water, and 1 mL of toluene. The reaction mixture was heated overnight at 50° C. to completely consume 10a according to tlc analysis. The reaction mixture was diluted with ethyl acetate and 1 N sodium hydroxide (10 mL). The layers were separated and the aqueous layer was extracted twice with ethyl acetate. The combined organic solution was dried (magnesium sulfate) and concentrated to afford 1.36 g of crude product. This material was filtered through a pad of flash silica gel and eluted with ethyl acetate to remove impurities, and then with 1:1 ethyl acetate:isopropanol with 5% added triethylamine to afford 0.92 g (82%) of S,R-11b.

A portion of this phosphinodiamine (0.71 g; 1.39 mmol) was combined with ester S,R-10a (952 mg; 2.09 mmol; 1.5 equiv) in 5 mL of isopropanol, 2 mL of water, and 1 mL of toluene. The mixture was heated overnight at 50° C., at which point tic analysis indicated some 11b residual. Additional S,R-10a (630 mg; 1.39 mmol; 1.0 equiv) and triethylamine (0.48 mL; 2.5 equiv) were added and the mixture was heated overnight at 50° C. to completely consume 11b according to tic analysis. The reaction mixture was diluted with ethyl acetate and 1 N sodium hydroxide (20 mL). The layers were separated and the aqueous layer was extracted twice with ethyl acetate. The combined organic solution was dried (magnesium sulfate) and concentrated to afford 2.27 g of crude product. This material was filtered through a pad of flash silica gel and eluted with 1:1 ethyl acetate:heptane to remove impurities, and then with 5% triethylamine in ethyl acetate to afford 0.79 g (63%) of S,R-8b as a yellow foam.

S,R-11b: ¹H NMR (CDCl₃) δ 7.6-7.2 (m, 10 H); 4.512 (s, 1H); 4.33 (m, 1H); 4.13 (m, 1H); 3.942 (s, 1H); 3.910 (s, 5H); 1.9-1.8 (m, 4H); 1.849 (d, J=8.04 Hz, 3H); 1.8-0.7 (m, 8H).

FDMS: m/e 852.14 (M⁺).

S,R-8b: ¹H NMR (CDCl₃) δ 7.7-7.1 (m, 20 H); 4.485 (br s, 2H); 4.32 (m, 2H); 3.92 (br s, 12H); 1.94 (br s, 2H); 1.8-0.3 (m, 14H).

FDMS: m/e 906.13 (M⁺).

### Example 4

### Preparation of N,N′-Bis[(S)-1-[(R)-2-Diphenylphosphino)ferrocenyl]ethyl (S,S)-1,2-cyclohexyldiamine (S,S-8b)

Ester S,R-10a (1.0 g; 2.19 mmol) was combined with S,S-1,2-diaminocyclohexane (500 mg; 4.38 mmol; 2 equiv) and triethylamine (0.92 mL; 6.57 mmol; 3 equiv) in 5 mL of isopropanol, 2 mL of water, and 1 mL of toluene. The reaction mixture was heated overnight at 50° C. to completely consume 10a according to tic analysis. The reaction mixture was diluted with ethyl acetate and 2 N sodium hydroxide (10 mL). The layers were separated and the aqueous layer was extracted twice with ethyl acetate. The combined organic solution was dried (magnesium sulfate) and concentrated to afford 1.58 g of crude product. This material was filtered through a pad of flash silica gel and eluted with 1:1 ethyl acetate:heptane to remove impurities, and then with 1:1 ethyl acetate:isopropanol with 5% added triethylamine to afford 0.84 g (75%) of S,S-11b.

A portion of this phosphinodiamine (0.74 g; 1.45 mmol) was combined with ester S,R-10a (0.99 g; 2.17 mmol; 1.5 equiv) in 5 mL of isopropanol, 2 mL of water, and 1 mL of toluene. Triethylamine (0.40 mL; 2.9 mmol; 2.0 equiv) was added and the mixture was heated overnight at 50° C., at which point tlc analysis indicated no 11b residual according to tlc analysis. The reaction mixture was diluted with ethyl acetate and 1 N sodium hydroxide (20 mL). The layers were separated and the aqueous layer was extracted twice with ethyl acetate. The combined organic solution was dried (magnesium sulfate) and concentrated to afford 2.03 g of crude product. This material was filtered through a pad of flash silica gel and eluted with 1:4 ethyl acetate:heptane to remove impurities, and then with 1:1 ethyl acetate:heptane with 5% added triethylamine to afford 0.98 g (75%) of S,S-8b as a yellow foam.

S,S-8b: ¹H NMR (CDCl₃) δ 7.6-7.1 (m, 20 H); 4.456 (br s, 2H); 4.228 (br s, 2H); 3.979 (s, 10H); 3.9 (m, 2H); 3.676 (br s, 2H); 1.69(br s, 2H); 1.6-0.4 (m, 14H).

### Example 5

### Preparation of N,N′-Bis[(R)-1-[(S)-2-Diphenylphosphino)ferrocenyl]ethyl (S,S)-1,2-cyclohexyldiamine (R,S-4b)

Ester R,S-6a (3.0 g; 6.6 mmol; 3 equiv) was combined with S,S-1,2-diaminocyclohexane tartrate salt (579 mg; 2.2 mmol) and triethylamine (1.84 mL; 13.2 mmol; 6 equiv) in 10 mL of isopropanol, 4 mL of water, and 2 mL of toluene. The reaction mixture was heated for 24 h at 50° C. to consume most of 6a according to tlc analysis. The reaction mixture was diluted with ethyl acetate and 1 N sodium hydroxide (20 mL). The layers were separated and the aqueous layer was extracted twice with ethyl acetate. The combined organic solution was dried (magnesium sulfate) and concentrated to afford 3.06 g of crude product. This material was filtered through a pad of flash silica gel and eluted with 1:1 ethyl acetate:heptane to remove impurities, and then with ethyl acetate to afford 1.60 g (80%) of R,S-4b.

### Example 6

### Preparation of N,N′-Bis[(S)-1-[(R)-2-Diphenylphosphino)ferrocenyl]ethyl (S,S)-1,2-diphenylethylenediamine (S,S-8c)

Ester S,R-10a (1.07 g; 2.36 mmol; 1.25 equiv) was combined with S,S-1,2-diphenylethylenediamine (400 mg; 1.88 mmol) and triethylamine (0.53 mL; 3.76 mmol; 2 equiv) in 5 mL of isopropanol, 2 mL of water, and 1 mL of toluene. The reaction mixture was heated overnight at 50° C. to completely consume 10a according to tlc analysis. The reaction mixture was diluted with ethyl acetate, water (10 mL), and 2 N sodium hydroxide (10 mL). The layers were separated and the aqueous layer was extracted twice with ethyl acetate. The combined organic solution was dried (magnesium sulfate) and concentrated to afford 1.58 g of crude product. This material was filtered through a pad of flash silica gel and eluted with 1:4 ethyl acetate:heptane to remove impurities, and then with 1:1 ethyl acetate:heptane with 5% added triethylamine to afford 0.67 g (58%) of S,S-11c.

A portion of this phosphinodiamine (0.57 g; 0.94 mmol) was combined with ester S,R-10a (534 mg; 1.17 mmol; 1.25 equiv) and triethylamine (0.20 mL; 1.41 mmol; 1.5 equiv) in 5 mL of isopropanol, 2 mL of water, and 1 mL of toluene, and the mixture was heated for 24 h at 50° C., at which point tlc analysis indicated no 10a but still some 11c residual. Additional S,R-10a (107 mg; 0.24 mmol; 0.25 equiv) and triethylamine (33 μL; 0.24 mmol; 0.25 equiv) were added and the mixture was stirred overnight at 50° C. to completely consume 11c. The reaction mixture was diluted with ethyl acetate and 1 N sodium hydroxide (20 mL). The layers were separated and the aqueous layer was extracted twice with ethyl acetate. The combined organic solution was dried (magnesium sulfate) and concentrated to afford 1.07 g of crude product. This material was flash-chromatographed and eluted with 1:9 ethyl acetate:heptane to afford 0.70 g (74%) of S,S-8c.

S,S-11c: ¹H NMR (CDCl₃) δ 7.8-7.2 (m, 10 H); 7.2-6.75 (m, 10H); 4.384 (br s, 1H); 4.27 (m, 1H); 3.910 (s, 5H); 3.82 (m, 1H); 3.714 (m, 1H); 3.482 (d, J=7.42 Hz, 1H); 2.05 (br s, 3H); 1.275 (d, J=6.59 Hz, 3H).

FDMS: m/e 608.09 (M⁺)

S,S-8c: ¹H NMR (DMSO-d₆) δ 7.6-6.5 (m, 30 H); 4.420 (m, 2H); 4.272 (m, 2H); 3.885 (s, 10H); 3.558 (m, 2H); 3.257 (m, 2H); 2.05 (m, 2H); 1.141 (d, J=7.14 Hz, 3H).

FDMS: m/e 1005.22 (M⁺)

### Example 7

### Preparation of N,N′-Bis[(S)-1-[(R)-2-Diphenylphosphino)ferrocenyl]ethyl (R,R)-1,2-diphenylethylenediamine (S,R-8c)

Ester S,R-10a (1.61 g; 3.5 mmol; 2.5 equiv) was combined with R,R-1,2-diphenylethylenediamine (300 mg; 1.41 mmol) and triethylamine (0.49 mL; 3.5 mmol; 2.5 equiv) in 5 mL of isopropanol, 2 mL of water, and 1 mL of toluene. The reaction mixture was heated overnight at 50° C. to afford incomplete formation of 8c (but complete consumption of 10a) according to tlc analysis. Additional S,R-10a (161 mg; 0.35 mmol; 0.25 equiv) and triethylamine (49 μL; 0.35 mmol; 0.25 equiv) were added and the reaction mixture was heated at 50° C. overnight to complete the formation of 8c according to tlc analysis. The reaction mixture was diluted with ethyl acetate, water (10 mL), and 2 N sodium hydroxide (2 mL). The layers were separated and the aqueous layer was extracted twice with ethyl acetate. The combined organic solution was dried (magnesium sulfate) and concentrated. The crude product was flash-chromatographed and eluted with 1:9 ethyl acetate:heptane to afford 0.79 g of S,R-8c which still contained some impurities. This material was recrystallized from 1:9 ethyl acetate:heptane to afford 456 mg (52%) of S,R-8c.

S,R-8c: ¹H NMR (DMSO-d₆) δ 7.6-7.0 (m, 20 H); 6.83 (m, 2H); 6.783 (t, J=6.59 Hz, 4H); 6.373 (d, J=7.14 Hz, 4H); 4.557 (br s, 2H); 4.371 (m, 2H); 3.951 (s, 10H); 3.784 (br s, 2H); 3.27 (m, 2H); 2.28 (m, 2H); 1.095 (d, J=6.59 Hz, 6H).

FDMS: m/e 1005.21 (M⁺)

### Example 8

### Preparation of (R)-1-[(S)-2-(Bis[3,5-dimethylphenyl]phosphino)ferrocenyl]ethyl acetate (R,S-6b)

(S)-N,N-Dimethyl-1-[(R)-2-(bis[3,5-dimethylphenyl]-phosphino)ferrocenyl]-ethylamine (R,S-5b, R³═R⁸═R⁹=methyl, R²=3,5-dimethylphenyl, R⁴═R⁵═H, M=Fe))(1.00 g; 2.01 mmol) was combined with acetic anhydride (3 mL; 32 mmol; 15.8 equivalents). The flask was evacuated and filled with nitrogen ten times and then heated to 70° C. for 4 hours, at which point thin layer chromatography (tlc) analysis indicated no 5b present. The residual acetic anhydride was evaporated at reduced pressure to afford 1.08 g (99%) of R,S-6b.

### Example 9

### Preparation of N,N′-Bis](R)-1-[(S)-2-([3,5-dimethylphenyl]phosphino)ferrocenyl]ethyl (S,S)-1,2-cyclohexyldiamine (R,S-4d)

Ester R,S-6b (961 mg; 1.88 mmol; 2.75 equiv) was combined with S,S-1,2-diaminocyclohexane tartrate salt (181 mg; 0.68 mmol) and triethylamine (0.57 mL; 4.1 mmol; 6 equiv) in 3.5 mL of isopropanol, 1.4 mL of water, and 0.7 mL of toluene. The reaction mixture was heated for 24 h at 50° C. to consume most of 6b according to tlc analysis. The reaction mixture was diluted with ethyl acetate and 1 N sodium hydroxide (15 mL). The layers were separated and the aqueous layer was extracted twice with ethyl acetate. The combined organic solution was dried (magnesium sulfate) and concentrated to afford 0.93 g of crude product. This material was filtered through a pad of flash silica gel and eluted with 1:1 ethyl acetate:heptane to remove impurities, and then with ethyl acetate to afford 405 mg (58%) of R,S-4d.

¹H NMR (CDCl₃) δ 7.207 (s, 2H); 7.179 (s, 2H); 7.003 (s, 2H); 6.820 (s, 2H); 6.793 (s, 4H); 4.485 (br s, 2H); 4.288 (m, 2H); 3.983 (s, 12H); 3.881 (br s, 2H); 2.320 (s, 6H); 2.172 (s, 6H); 2.4-0.4 (m, 10H); 1.531 (d, J=6.32 Hz, 6H).

FDMS: m/e 1018 (M⁺)

### Example 10

### Preparation of N,N′-Bis[(S)-1-[(R)-2-Diphenylphosphino)ferrocenyl]ethyl ethylenediamineruthenium(II) dichloride (S-13a)

Ligand S-8a (100 mg; 0.12 mmol)and p-cymeneruthenium dichloride dimer (36 mg; 0.06 mmol; 0.5 molar equiv) were combined. N,N-Dimethylformamide (3 mL) was added and the reaction mixture was evacuated and filled with nitrogen five times. The mixture was heated to 100° C. for 10 min to afford a homogeneous solution and then cooled. The volatiles were stripped in vacuo and the residue was dissolved in dichloromethane (1 mL) and diluted with tert-butyl methyl ether (20 mL) to afford S-13a as a precipitate. The solid was collected, washed with tert-butyl methyl ether, and dried in vacuo to afford 57 mg (46%) of S-13a.

FDMS: m/e 1024 (M⁺).

### Example 11

### Preparation of N,N′-Bis[(S)-1-[(R)-2-Diphenylphosphino)ferrocenyl]ethyl (R,R)-1,2-cyclohexyldiamineruthenium(II) dichloride (S,R-13b)

Ligand S,R-8b (200 mg; 0.22 mmol)and p-cymeneruthenium dichloride dimer (67.5 mg; 0.11 mmol; 0.5 molar equiv) were combined. N,N-Dimethylformamide (4 mL) was added and the reaction mixture was evacuated and filled with nitrogen five times. The mixture was heated to 100° C. for 10 min to afford a homogeneous solution and then cooled. The volatiles were stripped in vacuo and the residue was dissolved in dichloromethane (1 mL) and diluted with tert-butyl methyl ether to afford S,R-13b as a precipitate. The solid was collected, washed with tert-butyl methyl ether, and dried in vacuo to afford 108 mg (45%) of S,R-13b.

FDMS: m/e 1079 (M⁺).

### Example 12

### Preparation of N,N′-Bis[(S)-1-[(R)-2-Diphenylphosphino)ferrocenyl]ethyl (S,S)-1,2-cyclohexyldiamineruthenium(II) dichloride (S,S-13b)

Ligand S,S-8b (200 mg; 0.22 mmol)and p-cymeneruthenium dichloride dimer (67.5 mg; 0.11 mmol; 0.5 molar equiv) were combined. N,N-Dimethylformamide (4 mL) was added and the reaction mixture was evacuated and filled with nitrogen five times. The mixture was heated to 100° C. for 10 min to afford a homogeneous solution and then cooled. The volatiles were stripped in vacuo and the residue was dissolved in dichloromethane (1 mL) and diluted with tert-butyl methyl ether (20 mL) to afford S,S-13b as a precipitate. The solid was collected, washed with tert-butyl methyl ether, and dried in vacuo to afford 66 mg (28%) of S,S-13b.

### Example 13

### Preparation of N,N′-Bis[(R)-1-[(S)-2-Diphenylphosphino)ferrocenyl]ethyl (S,S)-1,2-cyclohexyldiamineruthenium(II) dichloride (R,S-13b)

Ligand R,S-4b (100 mg; 0.11 mmol)and p-cymeneruthenium dichloride dimer (33.8 mg; 0.055 mmol; 0.5 molar equiv) were combined. N,N-Dimethylformamide (2 mL) was added and the reaction mixture was evacuated and filled with nitrogen five times. The mixture was heated to 100° C. for 3 h to afford a homogeneous solution and then cooled to ambient temperature and stirred overnight. The volatiles were stripped in vacuo and the residue was dissolved in toluene (2 mL) and diluted with heptane (10 mL) to afford R,S-13b as a precipitate. The solid was collected, washed with heptane, and dried in vacuo to afford 56 mg (47%) of S,S-13b as a green solid.

### Example 14

### Preparation of N,N′-Bis[(S)-1-[(R)-2-Diphenylphosphino)ferrocenyl]ethyl (R,R)-1,2-diphenylethylenediamine ruthenium(II) dichloride (S,R-13c)

Ligand S,R-8c (200 mg; 0.20 mmol; 1.2 equiv)and p-cymeneruthenium dichloride dimer (51 mg; 0.083 mmol) were combined. N,N-Dimethylformamide (5 mL) was added and the reaction mixture was evacuated and filled with nitrogen five times. The mixture was heated to 100° C for 10 min to afford a homogeneous red solution and then cooled to 50° C. The volatiles were stripped in vacuo and the residue was dissolved in dichloromethane (1 mL) and diluted with tert-butyl methyl ether (10 mL) and heptane (10 mL) to afford S,R-13c as a precipitate. The solid was collected, washed with heptane, and dried in vacuo to afford 95 mg (49%) of S,R-13c.

### Example 15

### Preparation of N,N′-Bis[(S)-1-[(R)-2-Diphenylphosphino)ferrocenyl]ethyl (S,S)-1,2-diphenylethylenediamine ruthenium(II) dichloride (S,S-13c)

Ligand S,S-8c (200 mg; 0.20 mmol; 1.2 equiv)and p-cymeneruthenium dichloride dimer (51 mg; 0.083 mmol) were combined. N,N-Dimethylformamide (5 mL) was added and the reaction mixture was evacuated and filled with nitrogen five times. The mixture was heated to 100° C. for 10 min to afford a homogeneous red solution and then cooled to 50° C. The volatiles were stripped in vacuo and the residue was dissolved in dichloromethane (1 mL) and diluted with tert-butyl methyl ether (10 mL) and heptane (10 mL) to afford S,S-13c as a precipitate. The solid was collected, washed with heptane, and dried in vacuo to afford 113 mg (58%) of S,S-13c.

### Example 16

### Preparation of N,N′-Bis[(R)-1-[(S)-2-(Bis[3,5-dimethylphenyl]phosphino)-ferrocenyl]ethyl (S,S)-1,2-cyclohexyldiamineruthenium(II) dichloride (R,S-13d)

Ligand R,S-4d (100 mg; 0.098 mmol)and p-cymeneruthenium dichloride dimer (30.0 mg; 0.049 mmol; 0.5 molar equiv) were combined. N,N-Dimethylformamide (2 mL) was added and the reaction mixture was evacuated and filled with nitrogen five times. The mixture was heated to 100° C. for 1 h to afford a homogeneous solution and then cooled to ambient temperature and stirred overnight. The volatiles were stripped in vacuo and the residue was dissolved in toluene (2 mL) and diluted with heptane (10 mL) to afford R,S-13d as a precipitate. The solid was collected, washed with heptane, and dried in vacuo to afford 44 mg (38%) of R,S-13d as a green solid.

### Example 17

### Hydrogenation of Acetophenone to (R)-1-Phenylethanol using Complex (S)-13a

Complex S-13a (2.6 mg; 0.0025 mmol; 0.005 equiv) was placed in a reaction vessel, which was pressurized with argon and vented five times. Argon-degassed isopropanol (2 mL) was added and the mixture was stirred for 15 min. Acetophenone (58 μL; 0.5 mmol) dissolved in 1 mL of argon-degassed isopropanol was added and was washed in with 1.0 mL of argon-degassed isopropanol. Potassium tert-butoxide in tert-butanol (1M; 0.05 mL; 0.05 mmol; 0.1 equiv) in 0.5 mL of argon-degassed isopropanol was added and was washed in with 0.5 mL of isopropanol. The reaction mixture was pressurized with argon and vented five times and then pressurized to 300 psig with hydrogen and stirred at ambient temperature for 6 h. The vessel was vented, then pressurized with argon and vented five times, and the solution was assayed by chiral GC to indicate 100% conversion to R-1-phenylethanol with 58.6% ee.

Chiral GC [Cyclosil-B (J&W Scientific), 40° C. to 100° C. at 70° C./min, hold at 100° C. for 15 minutes, 100° C. to 170° C. at 15° C./min, hold at 170° C. for 7 min]: t_{R}=15.3 min (acetophenone), t_{R}=19.6 min (R-1-phenylethanol), t_{R}=19.8 min (S-1-phenylethanol).

### Example 18

### Hydrogenation of Acetylferrocene to (R)-1-Ferrocenylethanol using Complex (S)-13a

Complex S-13a (2.6 mg; 0.0025 mmol; 0.005 equiv) and acetylferrocene (114 mg; 0.5 mmol) were placed in a reaction vessel. The vessel was pressurized with argon and vented five times and 4 mL of argon-degassed isopropanol was added. Potassium tert-butoxide in tert-butanol (1 M; 0.05 mL; 0.05 mmol; 0.1 equiv) in 0.5 mL of argon-degassed isopropanol was added and was washed in with 0.5 mL of argon-degassed isopropanol. The reaction mixture was pressurized and vented with argon five times and then pressurized to 300 psig with hydrogen and stirred at ambient temperature for 6 h. The vessel was vented, then pressurized with argon and vented five times, and the solution was assayed by ¹H NMR to indicate >98% conversion to R-1-ferrocenylethanol which was 22.4% ee by chiral HPLC analysis.

Chiral HPLC [250×4.6 mm Chiralpak AS (Chiral Technologies), 90:10 hexane:isopropanol, 1 mL/min, λ=254 nm]: t_{R}=10.6 min (S-1-ferrocenylethanol), t_{R}=17.0 min (S-1-ferrocenylethanol).

### Example 19

### Hydrogenation of Cyclopropyl Methyl Ketone using Complex (S)-13a

Complex S-13a (2.6 mg; 0.0025 mmol; 0.005 equiv) was placed in a reaction vessel, which was pressurized with argon and vented five times. Argon-degassed isopropanol (2 mL) was added and the mixture was stirred for 15 min. Cyclopropyl methyl ketone (50 μL; 0.5 mmol) dissolved in 1.0 mL of argon-degassed isopropanol was added and was washed in with 1.0 mL of argon-degassed isopropanol. Potassium tert-butoxide in tert-butanol (1M; 0.05 mL; 0.05 mmol; 0.1 equiv) in 0.5 mL of argon-degassed isopropanol was added and was washed in with 0.5 mL of argon-degassed isopropanol. The reaction mixture was pressurized with argon and vented five times and then pressurized to 300 psig with hydrogen and stirred at ambient temperature for 6 h. The vessel was vented, then pressurized with argon and vented five times, and the solution was assayed by chiral GC to indicate 99.0% conversion to 1-cyclopropylethanol with 26.6% ee.

Chiral GC [Cyclosil-B (J&W Scientific), 55° C. isothermal]: t_{R}=7.3 (cyclopropyl methyl ketone), t_{R}=12.8 (1-cyclopropylethanol, enantiomer 1), t_{R}=13.4 (1-cyclopropylethanol, enantiomer 2).

### Example 20

### Hydrogenation of Acetophenone to (S)-1-Phenylethanol using Complex (S,R)-13b

Complex S,R-13b (2.7 mg; 0.0025 mmol; 0.005 equiv) was placed in a reaction vessel, which was pressurized with argon and vented five times. Argon-degassed isopropanol (2 mL) was added and the mixture was stirred for 15 min. Acetophenone (58 μL; 0.5 mmol) dissolved in 1 mL of argon-degassed isopropanol was added and was washed in with 1.0 mL of argon-degassed isopropanol. Potassium tert-butoxide in tert-butanol (1M; 0.05 mL; 0.05 mmol; 0.1 equiv) in 0.5 mL of argon-degassed isopropanol was added and was washed in with 0.5 mL of argon-degassed isopropanol. The reaction mixture was pressurized with argon and vented five times and then pressurized to 300 psig with hydrogen and stirred at ambient temperature for 6 h. The vessel was vented, then pressurized with argon and vented five times, and the solution was assayed by chiral GC to indicate 98.5% conversion to S-1-phenylethanol with 67.0% ee.

### Example 21

### Hydrogenation of Acetylferrocene to (S)-1-Ferrocenylethanol using Complex (S,R)-13b

Complex S,R-13b (2.7 mg; 0.0025 mmol; 0.005 equiv) and acetylferrocene (114 mg; 0.5 mmol) were placed in a reaction vessel. The vessel was pressurized with argon and vented five times and 4 mL of argon-degassed isopropanol was added. Potassium tert-butoxide in tert-butanol (1M; 0.05 mL; 0.05 mmol; 0.1 equiv) in 0.5 mL of argon-degassed isopropanol was added and was washed in with 0.5 mL of argon-degassed isopropanol. The reaction mixture was pressurized with argon and vented five times and then pressurized to 500 psig with hydrogen and stirred at ambient temperature for 6 h. The vessel was vented, then pressurized with argon and vented five times, and the solution was assayed by ¹H NMR to indicate 98.5% conversion to S-1-ferrocenylethanol which was 78% ee by chiral HPLC analysis.

### Example 22

### Hydrogenation of Acetophenone to (S)-1-Phenylethanol using in situ Prepared Complex (S,R)-13b

Ligand S,R-8b (2.7 mg; 0.003 mmol; 0.006 equiv) and p-cymeneruthenium chloride dimer (0.8 mg; 0.0013 mmol; 0.0025 molar equiv) were placed in a reaction vessel, which was pressurized with argon and vented five times. Argon-degassed isopropanol (2 mL) was added and the mixture was stirred for 15 min. Acetophenone (58 μL; 0.5 mmol) dissolved in 1 mL of argon-degassed isopropanol was added and was washed in with 1.0 mL of argon-degassed isopropanol. Potassium tert-butoxide in tert-butanol (1M; 0.05 mL; 0.05 mmol; 0.1 equiv) in 0.5 mL of argon-degassed isopropanol was added and was washed in with 0.5 mL of argon-degassed isopropanol. The reaction mixture was pressurized with argon and vented five times and then pressurized to 300 psig with hydrogen and stirred at ambient temperature for 6 h. The vessel was vented, then pressurized with argon and vented five times, and the solution was assayed by chiral GC to indicate 99.9% conversion to S-1-phenylethanol with 54.4% ee.

### Example 23

### Hydrogenation of Acetylferrocene to (S)-1-Ferrocenylethanol using in situ Prepared Complex (S R)-13b

Ligand S,R-8b (2.7 mg; 0.003 mmol; 0.006 equiv), p-cymeneruthenium chloride dimer (0.8 mg; 0.0013 mmol; 0.0025 molar equiv), and acetylferrocene (114 mg; 0.5 mmol) were placed in a reaction vessel. The vessel was pressurized with argon and vented five times and 4 mL of argon-degassed isopropanol was added. The mixture was stirred for 15 min. Potassium tert-butoxide in tert-butanol (1M; 0.05 mL; 0.05 mmol; 0.1 equiv) in 0.5 mL of argon-degassed isopropanol was added and was washed in with 0.5 mL of argon-degassed isopropanol. The reaction mixture was pressurized with argon and vented five times and then pressurized to 300 psig with hydrogen and stirred at ambient temperature for 6 h. The vessel was vented, then pressurized with argon and vented five times, and the solution was assayed by ¹H NMR to indicate 79% conversion to S-1-ferrocenylethanol which was 70% ee by chiral HPLC analysis.

### Example 24

### Hydrogenation of Acetylferrocene to (S)-1-Ferrocenylethanol using Complex (S,R)-13b in Tetrahydrofuran (THF)

Complex S,R-13b (2.7 mg; 0.0025 mmol; 0.005 equiv) and acetylferrocene (114 mg; 0.5 mmol) were placed in a reaction vessel. The vessel was pressurized and vented with argon five times and 4 mL of argon-degassed THF was added. Potassium tert-butoxide in tert-butanol (1M; 0.05 mL; 0.05 mmol; 0.1 equiv) in 0.5 mL of argon-degassed THF was added and was washed in with 0.5 mL of argon-degassed THF. The reaction mixture was pressurized with argon and vented five times and then pressurized to 300 psig with hydrogen and stirred at ambient temperature for 6 h. The vessel was vented, then pressurized with argon and vented five times, and the solution was assayed by ¹H NMR to indicate 12% conversion to S-1-ferrocenylethanol which was 72% ee by chiral HPLC analysis.

### Example 25

### Hydrogenation of Acetylferrocene to (S)-1-Ferrocenylethanol using Complex (S,R)-13b in Toluene

Complex S,R-13b (2.7 mg; 0.0025 mmol; 0.005 equiv) and acetylferrocene (114 mg; 0.5 mmol) were placed in a reaction vessel. The vessel was pressurized with argon and vented five times and 4 mL of argon-degassed toluene was added. Potassium tert-butoxide in tert-butanol (1M; 0.05 mL; 0.05 mmol; 0.1 equiv) in 0.5 mL of argon-degassed toluene was added and was washed in with 0.5 mL of argon-degassed toluene. The reaction mixture was pressurized with argon and vented five times and then pressurized to 300 psig with hydrogen and stirred at ambient temperature for 6 h. The vessel was vented, then pressurized with argon and vented five times, and the solution was assayed by ¹H NMR to indicate 87% conversion to S-1-ferrocenylethanol which was 13% ee by chiral HPLC analysis.

### Example 26

### Hydrogenation of Acetylferrocene to (S)-1-Ferrocenylethanol using Complex (S,R)-13b at Substrate:Catalyst Ratio of 500:1

Complex S,R-13b (2.2 mg; 0.002 mmol; 0.002 equiv) and acetylferrocene (228 mg; 1.0 mmol) were placed in a reaction vessel. The vessel was pressurized with argon and vented five times and 4 mL of argon-degassed isopropanol was added. Potassium tert-butoxide in tert-butanol (1M; 0.10 mL; 0.10 mmol; 0.1 equiv) in 0.5 mL of argon-degassed isopropanol was added and was washed in with 0.5 mL of argon-degassed isopropanol. The reaction mixture was pressurized with argon and vented five times and then pressurized to 300 psig with hydrogen and stirred at ambient temperature for 6 h. The vessel was vented, then pressurized with argon and vented five times, and the solution was assayed by ¹H NMR to indicate 67% conversion to S-1-ferrocenylethanol which was 80% ee by chiral HPLC analysis.

### Example 27

Hydrogenation of Acetylferrocene to (S)-1-Ferrocenylethanol using Complex (S,R)-13b at Substrate:Catalyst Ratio of 500:1 and at 100 psig Hydrogen

Complex S,R-13b (2.2 mg; 0.002 mmol; 0.002 equiv) and acetylferrocene (228 mg; 1.0 mmol) were placed in a reaction vessel. The vessel was pressurized with argon and vented five times and 4 mL of argon-degassed isopropanol was added. Potassium tert-butoxide in tert-butanol (1M; 0.10 mL; 0.10 mmol; 0.1 equiv) in 0.5 mL of argon-degassed isopropanol was added and was washed in with 0.5 mL of argon-degassed isopropanol. The reaction mixture was pressurized with argon and vented five times and then pressurized to 100 psig with hydrogen and stirred at ambient temperature for 6 h. The vessel was vented, then pressurized with argon and vented five times, and the solution was assayed by ¹H NMR to indicate 20% conversion to S-1-ferrocenylethanol which was 70% ee by chiral HPLC analysis.

### Example 28

### Hydrogenation of Acetylferrocene to (S)-1-Ferrocenylethanol using Complex (S,R)-13b at Substrate:Catalyst Ratio of 500:1 and at 200 psig Hydrogen

Complex S,R-13b (2.2 mg; 0.002 mmol; 0.002 equiv) and acetylferrocene (228 mg; 1.0 mmol) were placed in a reaction vessel. The vessel was pressurized with argon and vented five times and 4 mL of argon-degassed isopropanol was added. Potassium tert-butoxide in tert-butanol (1M; 0.10 mL; 0.10 mmol; 0.1 equiv) in 0.5 mL of argon-degassed isopropanol was added and was washed in with 0.5 mL of argon-degassed isopropanol. The reaction mixture was pressurized with argon and vented five times and then pressurized to 200 psig with hydrogen and stirred at ambient temperature for 6 h. The vessel was vented, then pressurized with argon and vented five times, and the solution was assayed by ¹H NMR to indicate 45% conversion to S-1-ferrocenylethanol which was 77% ee by chiral HPLC analysis.

### Example 29

### Hydrogenation of Acetylferrocene to (S)-1-Ferrocenylethanol using Complex (S,R)-13b at Substrate:Catalyst Ratio of 1000:1

Complex S,R-13b (2.7 mg; 0.0025 mmol; 0.001 equiv) and acetylferrocene (570 mg; 2.5 mmol) were placed in a reaction vessel. The vessel was pressurized with argon and vented five times and 4 mL of argon-degassed isopropanol was added. Potassium tert-butoxide in tert-butanol (1M; 0.125 mL; 0.125 mmol; 0.05 equiv) in 0.5 mL of argon-degassed isopropanol was added and was washed in with 0.5 mL of argon-degassed isopropanol. The reaction mixture was pressurized with argon and vented five times and then pressurized to 300 psig with hydrogen and stirred at ambient temperature for 6 h. The vessel was vented, then pressurized with argon and vented five times, and the solution was assayed by ¹H NMR to indicate 78% conversion to S-1-ferrocenylethanol which was 73% ee by chiral HPLC analysis.

### Example 30

### Hydrogenation of Acetophenone to (R)-1-Phenylethanol using Complex (S,S)-13b

Complex S,S-13b (2.7 mg; 0.0025 mmol; 0.005 equiv) was placed in a reaction vessel, which was pressurized with argon and vented five times. Argon-degassed isopropanol (2 mL) was added and the mixture was stirred for 15 min. Acetophenone (58 μL; 0.5 mmol) dissolved in 1 mL of argon-degassed isopropanol was added and was washed in with 1.0 mL of argon-degassed isopropanol. Potassium tert-butoxide in tert-butanol (1M; 0.05 mL; 0.05 mmol; 0.1 equiv) in 0.5 mL of argon-degassed isopropanol was added and was washed in with 0.5 mL of argon-degassed isopropanol. The reaction mixture was pressurized with argon and vented five times and then pressurized to 300 psig with hydrogen and stirred at ambient temperature for 6 h. The vessel was vented, then pressurized with argon and vented five times, and the solution was assayed by chiral GC to indicate 99.1% conversion to R-1-phenylethanol with 57.2% ee.

### Example 31

### Hydrogenation of Acetylferrocene to (R)-1-Ferrocenylethanol using Complex (S,S)-13b

Complex S,S-13b (2.7 mg; 0.0025 mmol; 0.005 equiv) and acetylferrocene (114 mg; 0.5 mmol) were placed in a reaction vessel. The vessel was pressurized with argon and vented five times and 4 mL of argon-degassed isopropanol was added. Potassium tert-butoxide in tert-butanol (1M; 0.05 mL; 0.05 mmol; 0.1 equiv) in 0.5 mL of argon-degassed isopropanol was added and was washed in with 0.5 mL of argon-degassed isopropanol. The reaction mixture was pressurized with argon and vented five times and then pressurized to 300 psig with hydrogen and stirred at ambient temperature for 6 h. The vessel was vented, then pressurized with argon and vented five times, and the solution was assayed by ¹H NMR to indicate 99% conversion to R-1-ferrocenylethanol which was 47% ee by chiral HPLC analysis.

### Example 32

### Hydrogenation of Acetophenone to (R)-1-Phenylethanol using in situ prepared Complex (S,S)-13b

Ligand S,S-8b (2.7 mg; 0.003 mmol; 0.006 equiv) and p-cymeneruthenium chloride dimer (0.8 mg; 0.0013 mmol; 0.0025 molar equiv) were placed in a reaction vessel, which was pressurized with argon and vented five times. Argon-degassed isopropanol (2 mL) was added and the mixture was stirred for 15 min. Acetophenone (58 μL; 0.5 mmol) dissolved in 1 mL of argon-degassed isopropanol was added and was washed in with 1.0 mL of argon-degassed isopropanol. Potassium tert-butoxide in tert-butanol (1M; 0.05 mL; 0.05 mmol; 0.1 equiv) in 0.5 mL of argon-degassed isopropanol was added and was washed in with 0.5 mL of argon-degassed isopropanol. The reaction mixture was pressurized with argon and vented five times and then pressurized to 300 psig with hydrogen and stirred at ambient temperature for 6 h. The vessel was vented, then pressurized with argon and vented five times, and the solution was assayed by chiral GC to indicate 99.1% conversion to R-1-phenylethanol with 66.0% ee.

### Example 33

### Hydrogenation of Acetylferrocene to (S)-1-Ferrocenylethanol using in situ Prepared Complex (S,S)-13b

Ligand S,S-8b (2.7 mg; 0.003 mmol; 0.006 equiv), p-cymeneruthenium chloride dimer (0.8 mg; 0.0013 mmol; 0.0025 molar equiv), and acetylferrocene (114 mg; 0.5 mmol) were placed in a reaction vessel. The vessel was pressurized with argon and vented five times and 4 mL of argon-degassed isopropanol was added. The mixture was stirred for 15 min. Potassium tert-butoxide in tert-butanol (1M; 0.05 mL; 0.05 mmol; 0.1 equiv) in 0.5 mL of argon-degassed isopropanol was added and was washed in with 0.5 mL of argon-degassed isopropanol. The reaction mixture was pressurized with argon and vented five times and then pressurized to 300 psig with hydrogen and stirred at ambient temperature for 6 h. The vessel was vented, then pressurized with argon and vented five times, and the solution was assayed by ¹H NMR to indicate 55% conversion to R-1-ferrocenylethanol which was 58% ee by chiral HPLC analysis.

### Example 34

### Hydrogenation of Acetophenone to (S)-1-Phenylethanol using Complex (S,R)-13c

Complex S,R-13c (2.9 mg; 0.0025 mmol; 0.005 equiv) was placed in a reaction vessel, which was pressurized with argon and vented five times. Argon-degassed isopropanol (2 mL) was added and the mixture was stirred for 15 min. Acetophenone (58 μL; 0.5 mmol) dissolved in 1 mL of argon-degassed isopropanol was added and was washed in with 1.0 mL of argon-degassed isopropanol. Potassium tert-butoxide in tert-butanol (1M; 0.05 mL; 0.05 mmol; 0.1 equiv) in 0.5 mL of argon-degassed isopropanol was added and was washed in with 0.5 mL of argon-degassed isopropanol. The reaction mixture was pressurized with argon and vented five times and then pressurized to 300 psig with hydrogen and stirred at ambient temperature for 6 h. The vessel was vented, then pressurized with argon and vented five times, and the solution was assayed by chiral GC to indicate 72.5% conversion to S-1-phenylethanol with 2% ee.

### Example 35

### Hydrogenation of Acetylferrocene to (S)-1-Ferrocenylethanol using Complex (S,R)-13c

Complex S,R-13c (2.9 mg; 0.0025 mmol; 0.005 equiv) and acetylferrocene (114 mg; 0.5 mmol) were placed in a reaction vessel. The vessel was pressurized with argon and vented five times and 4 mL of argon-degassed isopropanol was added. Potassium tert-butoxide in tert-butanol (1M; 0.05 mL; 0.05 mmol; 0.1 equiv) in 0.5 mL of argon-degassed isopropanol was added and was washed in with 0.5 mL of argon-degassed isopropanol. The reaction mixture was pressurized with argon and vented five times and then pressurized to 300 psig with hydrogen and stirred at ambient temperature for 6 h. The vessel was vented, then pressurized with argon and vented five times, and the solution was assayed by ¹H NMR to indicate 9% conversion to S-1-ferrocenylethanol which was 24% ee by chiral HPLC analysis.

### Example 36

### Hydrogenation of Acetophenone to (R)-1-Phenylethanol using Complex (S,S)-13c

Complex S,S-13c (2.9 mg; 0.0025 mmol; 0.005 equiv) was placed in a reaction vessel, which was pressurized with argon and vented five times. Argon-degassed isopropanol (2 mL) was added and the mixture was stirred for 15 min. Acetophenone (58 μL; 0.5 mmol) dissolved in 1 mL of argon-degassed isopropanol was added and was washed in with 1.0 mL of argon-degassed isopropanol. Potassium tert-butoxide in tert-butanol (1M; 0.05 mL; 0.05 mmol; 0.1 equiv) in 0.5 mL of argon-degassed isopropanol was added and was washed in with 0.5 mL of argon-degassed isopropanol. The reaction mixture was pressurized with argon and vented five times and then pressurized to 300 psig with hydrogen and stirred at ambient temperature for 6 h. The vessel was vented, then pressurized with argon and vented five times, and the solution was assayed by chiral GC to indicate 74.5% conversion to R-1-phenylethanol with 51.2% ee.

### Example 37

### Hydrogenation of Acetylferrocene to (R)-1-Ferrocenylethanol using Complex (S,S)-13c

Complex S,S-13c (2.9 mg; 0.0025 mmol; 0.005 equiv) and acetylferrocene (114 mg; 0.5 mmol) were placed in a reaction vessel. The vessel was pressurized with argon and vented five times and 4 mL of argon-degassed isopropanol was added. Potassium tert-butoxide in tert-butanol (1M; 0.05 mL; 0.05 mmol; 0.1 equiv) in 0.5 mL of argon-degassed isopropanol was added and was washed in with 0.5 mL of argon-degassed isopropanol. The reaction mixture was pressurized with argon and vented five times and then pressurized to 300 psig with hydrogen and stirred at ambient temperature for 6 h. The vessel was vented, then pressurized with argon and vented five times, and the solution was assayed by ¹H NMR to indicate 56% conversion to R-1-ferrocenylethanol which was 40% ee by chiral HPLC analysis.

### Example 38

### Hydrogenation of Acetophenone to (R)-1-Phenylethanol using Complex (R,S)-13d

Complex R,S-13d (3.0 mg; 0.0025 mmol; 0.005 equiv) was placed in a reaction vessel, which was pressurized with argon and vented five times. Argon-degassed isopropanol (2 mL) was added and the mixture was stirred for 15 min. Acetophenone (58 μL; 0.5 mmol) dissolved in 1 mL of argon-degassed isopropanol was added and was washed in with 1.0 mL of argon-degassed isopropanol. Potassium tert-butoxide in tert-butanol (1M; 0.05 mL; 0.05 mmol; 0.1 equiv) in 0.5 mL of argon-degassed isopropanol was added and was washed in with 0.5 mL of argon-degassed isopropanol. The reaction mixture was pressurized with argon and vented five times and then pressurized to 300 psig with hydrogen and stirred at ambient temperature for 6 h. The vessel was vented, then pressurized with argon and vented five times, and the solution was assayed by chiral GC to indicate 99.0% conversion to R-1-phenylethanol with 60.0% ee.

### Example 39

### Hydrogenation of Acetylferrocene to (R)-1-Ferrocenylethanol using Complex (R,S)-13d

Complex R,S-13d (3.0 mg; 0.0025 mmol; 0.005 equiv) and acetylferrocene (114 mg; 0.5 mmol) were placed in a reaction vessel. The vessel was pressurized with argon and vented five times and 4 mL of argon-degassed isopropanol was added. The reaction mixture was stirred for 15 min and potassium tert-butoxide in tert-butanol (1M; 0.05 mL; 0.05 mmol; 0.1 equiv) in 0.5 mL of argon-degassed isopropanol was added and was washed in with 0.5 mL of argon-degassed isopropanol. The reaction mixture was pressurized with argon and vented five times and then pressurized to 300 psig with hydrogen and stirred at ambient temperature for 6 h. The vessel was vented, then pressurized with argon and vented five times, and the solution was assayed by chiral HPLC to indicate 44% ee for R-1-ferrocenylethanol.

### Example 40

### Hydrogenation of 4-Trifluoromethylacetophenone using Complex(R,S)-13d

Complex R,S-13d (3.0 mg; 0.0025 mmol; 0.005 equiv) was placed in a reaction vessel, which was pressurized with argon and vented five times. Argon-degassed isopropanol (2 mL) was added and the mixture was stirred for 15 min. 4-Trifluoromethylacetophenone (94 mg; 0.5 mmol) dissolved in 1 mL of argon-degassed isopropanol was added and was washed in with 1.0 mL of argon-degassed isopropanol. Potassium tert-butoxide in tert-butanol (1M; 0.05 mL; 0.05 mmol; 0.1 equiv) in 0.5 mL of argon-degassed isopropanol was added and was washed in with 0.5 mL of argon-degassed isopropanol. The reaction mixture was pressurized with argon and vented five times and then pressurized to 300 psig with hydrogen and stirred at ambient temperature for 6 h. The vessel was vented, then pressurized with argon and vented five times, and the solution was assayed by chiral GC to indicate 99.8% conversion to 1-(4-trifluoromethylphenyl)ethanol with 60.0% ee.

Chiral GC [Cyclosil-B (J&W Scientific), 40° C. to 100° C. at 70° C./min, hold at 100° C. for 15 minutes, 100° C. to 170° C. at 15° C./min, hold at 170° C. for 7 min]: t^{R}=16.7 min (4-trifluoromethylacetophenone), t^{R}=20.7 min [1-(4-trifluoromethylphenyl)ethanol, enantiomer 1], t_{R}=20.9 min [1-(4-trifluoromethylphenyl)ethanol, enantiomer 2].

### Example 41

### Hydrogenation of 4-Methoxyacetophenone using Complex (R,S)-13d

Complex R,S-13d (3.0 mg; 0.0025 mmol; 0.005 equiv) was placed in a reaction vessel, which was pressurized with argon and vented five times. Argon-degassed isopropanol (2 mL) was added and the mixture was stirred for 15 min. 4-Methoxyacetophenone (75 mg; 0.5 mmol) dissolved in 1 mL of argon-degassed isopropanol was added and was washed in with 1.0 mL of argon-degassed isopropanol. Potassium tert-butoxide in tert-butanol (1M; 0.05 mL; 0.05 mmol; 0.1 equiv) in 0.5 mL of argon-degassed isopropanol was added and was washed in with 0.5 mL of argon-degassed isopropanol. The reaction mixture was pressurized with argon and vented five times and then pressurized to 300 psig with hydrogen and stirred at ambient temperature for 6 h. The vessel was vented, then pressurized with argon and vented five times, and the solution was assayed by chiral GC to indicate 99.7% conversion to 1-(4-methoxyphenyl)ethanol with 55.0% ee.

Chiral GC [Cyclosil-B (J&W Scientific), 40° C. to 100° C. at 70° C./min, hold at 100° C. for 15 minutes,100° C. to 170° C. at 15° C./min, hold at 170° C. for 7 min]: t_{R}=23.2 min (4-methoxyacetophenone), t_{R}=23.7 min [1-(4-methoxyphenyl)ethanol, enantiomer 1], t_{R}=23.8 min [1-(4-methoxyphenyl)ethanol, enantiomer 2].

### Example 42

### Hydrogenation of 2′-Acetonaphthone using Complex (R,S)-13d

Complex R,S-13d (3.0 mg; 0.0025 mmol; 0.005 equiv) was placed in a reaction vessel, which was pressurized with argon and vented five times. Argon-degassed isopropanol (2 mL) was added and the mixture was stirred for 15 min. 2′-Acetonaphthone (85 mg; 0.5 mmol) dissolved in 1 mL of argon-degassed isopropanol was added and was washed in with 1.0 mL of argon-degassed isopropanol. Potassium tert-butoxide in tert-butanol (1M; 0.05 mL; 0.05 mmol; 0.1 equiv) in 0.5 mL of argon-degassed isopropanol was added and was washed in with 0.5 mL of argon-degassed isopropanol. The reaction mixture was pressurized with argon and vented five times and then pressurized to 300 psig with hydrogen and stirred at ambient temperature for 6 h. The vessel was vented, then pressurized with argon and vented five times, and the solution was assayed by chiral GC to indicate 99.8% conversion to 1-(2-naphthyl)ethanol with 63.2% ee.

Chiral GC [Cyclosil-B (J&W Scientific), 165° C. for 15 minutes, 165° C. to 200° C. at 150° C./min, hold at 200° C. for 15 min]: t_{R}=17.7 min (2′-acetonaphthone), t_{R}=19.26 min [1-(2-naphthyl)ethanol, enantiomer 1], t_{R}=19.35 min [1-(2-naphthyl)ethanol, enantiomer 2].

The invention has been described in detail with particular reference to preferred embodiments thereof, but it will be understood that variations and modifications can be effected within the spirit and scope of the invention.

1. A substantially enantiomerically pure compound having the general formula 1:
R₂P-L¹-NH-L²-NH-L³-PR¹₂ 1
wherein R and R¹ are, independently, branched- or straight-chain C₁-C₂₀ alkyl, C₃-C₈ cycloalkyl, C₆-C₂₀ carbocyclic aryl, or a C₄-C₂₀ heteroaryl having from one to three heteroatoms selected from sulfur, nitrogen, and oxygen; L¹, L², and L³ may be the same or different, and are divalent radicals selected from branched- or straight-chain C₁-C₂₀ alkyl, C₃-C₈ cycloalkyl, C₆-C₂₀ carbocyclic aryl, a C₄-C₂₀ heteroaryl having from one to three heteroatoms selected from sulfur, nitrogen, and oxygen, or metallocenylalkyl and wherein L¹, L³ and, optionally, L² are substantially enantiomerically pure.

2. A compound as claimed in claim 1, wherein R₂P-L¹-NH— and R¹₂P-L³-NH— are the same or different and are selected from the structure in formula 2 or formula 3 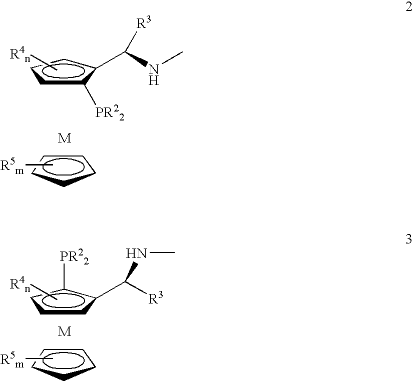
wherein
each R² is independently a branched- or straight-chain C₁-C₂₀ alkyl, C₃-C₈ cycloalkyl, C₆-C₂₀ carbocyclic aryl, or a C₄-C₂₀ heteroaryl having from one to three heteroatoms selected from sulfur, nitrogen, or oxygen;
each R³, R⁴, and R⁵ is independently selected from hydrogen, branched- or straight-chain C₁-C₂₀ alkyl, C₃-C₈ cycloalkyl, C₆-C₂₀ carbocyclic aryl, or C₄-C₂₀ heteroaryl having from one to three heteroatoms selected from sulfur, nitrogen, and oxygen;
n is 0 to 3;
m is 0 to 5; and
M is selected from the metals of Groups IVB, VB, VIB, VIIB and VIII.

3. A compound as claimed in claim 2 wherein wherein R₂P-L¹-NH— and R¹₂P-L³-NH— are according to the structure of formula 2.

4. A compound as claimed in claim 2 wherein wherein R₂P-L¹-NH— and R¹₂P-L³-NH— are according to the structure of formula 3.

5. A compound as claimed in claim 2 wherein R² is aryl; R³ is hydrogen or C₁ to C₆ alkyl; R⁴ and R⁵ are hydrogen; and M is iron, ruthenium, or osmium.

6. A compound as claimed in claim 5 wherein R² is phenyl or 3,5-dimethylphenyl; R³ is hydrogen or methyl; and M is iron.

7. A compound according to claim 2 wherein L² is an achiral, racemic, enantiomerically enriched or substantially enantiomerically pure substituted or unsubstituted C₁-C₂₀ alkylene, C₃-C₈ cycloalkylene, or 1,1′-biaryl-2,2′-diyl.

8. A compound comprising a substantially enantiomerically pure compound defined in claim 2 in complex association with a Group VIII metal.

9. A compound having formula 7 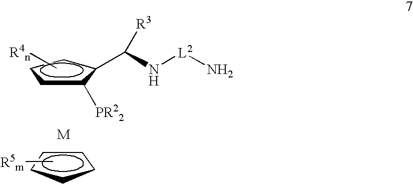
wherein
R² is a branched- or straight-chain C₁-C₂₀ alkyl, C₃-C₈ cycloalkyl, C₆-C₂₀ carbocyclic aryl, or a C₄-C₂₀ heteroaryl having from one to three heteroatoms selected from sulfur, nitrogen, or oxygen;
R³, R⁴, and R⁵ are independently hydrogen, branched- or straight-chain C₁-C₂₀ alkyl, C₃-C₈ cycloalkyl, C₆-C₂₀ carbocyclic aryl, or C₄-C₂₀ heteroaryl having one to three heteroatoms wherein the heteroatoms are selected from sulfur, nitrogen, and oxygen;
L² is an achiral, racemic, enantiomerically enriched or substantially enantiomerically pure C₁-C₂₀ alkylene, C₃-C₈ cycloalkylene, or 1,1′-biaryl-2,2′-diyl;
n is 0 to 3;
m is 0 to 5; and
M is selected from the metals of Groups IVB, VB, VIB, VIIB and VIII.

10. A compound as claimed in claim 9 wherein R² is aryl; R³ is hydrogen or C₁ to C₆ alkyl; R⁴ and R⁵ are hydrogen, L² is 1,2-ethanediyl, 1,3-propanediyl, 1,4-butanediyl, substantially enantiomerically pure 1,2-diphenyl-1,2-ethanediyl, substantially enantiomerically pure trans-1,2-cyclohexanediyl, or substantially enantiomerically pure 1,1′-binaphth-2,2′-diyl, and M is iron.

11. A compound having formula 11 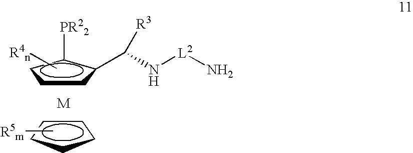
wherein
R² is a branched- or straight-chain C₁-C₂₀ alkyl, C₃-C₈ cycloalkyl, C₆-C₂₀ carbocyclic aryl, or a C₄-C₂₀ heteroaryl having from one to three heteroatoms selected from sulfur, nitrogen, or oxygen;
R³, R⁴, and R⁵ are independently hydrogen, branched- or straight-chain C₁-C₂₀ alkyl, C₃-C₈ cycloalkyl, C₆-C₂₀ carbocyclic aryl, or C₄-C₂₀ heteroaryl having one to three heteroatoms wherein the heteroatoms are selected from sulfur, nitrogen, and oxygen;
L² is an achiral, racemic, enantiomerically enriched or substantially enantiomerically pure C₁-C₂₀ alkylene, C₃-C₈ cycloalkylene, or 1,1′-biaryl-2,2′-diyl;
n is 0 to 3;
m is 0 to 5; and
M is selected from the metals of Groups IVB, VB, VIB, VIIB and VIII.

12. A compound as claimed in claim 11 wherein R² is aryl; R³ is hydrogen or C₁ to C₆ alkyl; R⁴ and R⁵ are hydrogen, L² is 1,2-ethanediyl, 1,3-propanediyl, 1,4-butanediyl, substantially enantiomerically pure 1,2-diphenyl-1,2-ethanediyl, substantially enantiomerically pure trans-1,2-cyclohexanediyl, or substantially enantiomerically pure 1,1′-binaphth-2,2′-diyl, and M is iron.

13. A compound according to claim 1 having formula 4 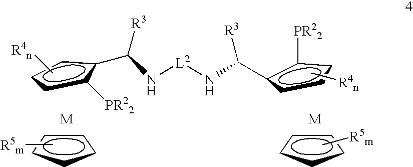
wherein
each R² is independently a branched- or straight-chain C₁-C₂₀ alkyl, C₃-C₈ cycloalkyl, C₆-C₂₀ carbocyclic aryl, or a C₄-C₂₀ heteroaryl having from one to three heteroatoms selected from sulfur, nitrogen, or oxygen;
each R³, R⁴, and R⁵ is, independently, hydrogen, branched- or straight-chain C₁-C₂₀ alkyl, C₃-C₈ cycloalkyl, C₆-C₂₀ carbocyclic aryl, or C₄-C₂₀ heteroaryl having from one to three heteroatoms selected from sulfur, nitrogen, and oxygen;
L² is an achiral, racemic, enantiomerically enriched or substantially enantiomerically pure C₁-C₂₀ alkylene, C₃-C₈ cycloalkylene, or 1,1′-biaryl-2,2′-diyl;
n is 0 to 3;
m is 0 to 5; and
M is selected from the metals of Groups IVB, VB, VIB, VIIB and VIII.

14. A compound as claimed in claim 13 wherein each R² is aryl; each R³ is hydrogen or C₁ to C₆ alkyl; each R⁴ and R⁵ is hydrogen; and M is iron, ruthenium, or osmium.

15. A compound as claimed in claim 14 wherein each R² is phenyl or 3,5-dimethylphenyl; each R³ is hydrogen or methyl; L² is 1,2-ethanediyl, 1,3-propanediyl, 1,4-butanediyl, substantially enantiomerically pure 1,2-diphenyl 1,2-ethanediyl, substantially enantiomerically pure trans-1,2-cyclohexanediyl, or substantially enantiomerically pure 1,1′-binaphth-2,2′-diyl and M is iron.

16. A compound comprising a substantially enantiomerically pure compound defined in claim 13 in complex association with a Group VIII metal.

17. A compound as claimed in claim 16 wherein the Group VIII metal is ruthenium, iridium or rhodium.

18. A compound according to claim 1 having formula 8 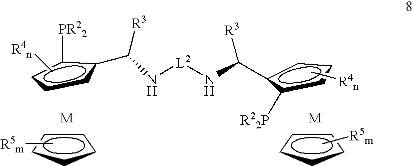
wherein
each R² is independently a branched- or straight-chain C₁-C₂₀ alkyl, C₃-C₈ cycloalkyl, C₆-C₂₀ carbocyclic aryl, or a C₄-C₂₀ heteroaryl having from one to three heteroatoms selected from sulfur, nitrogen, or oxygen;
each R³, R⁴, and R⁵ is independently selected from hydrogen, branched- or straight-chain C₁-C₂₀ alkyl, C₃-C₈ cycloalkyl, C₆-C₂₀ carbocyclic aryl, or C₄-C₂₀ heteroaryl having from one to three heteroatoms selected from sulfur, nitrogen, and oxygen;
L² is an achiral, racemic, enantiomerically enriched or substantially enantiomerically pure C₁-C₂₀ alkylene, C₃-C₈ cycloalkylene, or 1,1′-biaryl-2,2′-diyl;
n is 0 to 3;
m is 0 to 5; and
M is selected from the metals of Groups IVB, VB, VIB, VIIB and VIII.

19. A compound as claimed in claim 18 wherein each R² is aryl; each R³ is hydrogen or C₁ to C₆ alkyl; each R⁴ and R⁵ is hydrogen; and M is iron, ruthenium, or osmium.

20. A compound as claimed in claim 19 wherein each R² is phenyl or 3,5-dimethylphenyl; each R³ is hydrogen or methyl; L² is 1,2-ethanediyl, 1,3-propanediyl, 1,4-butanediyl, substantially enantiomerically pure 1,2-diphenyl-1,2-ethanediyl, substantially enantiomerically pure trans-1,2-cyclohexanediyl, or substantially enantiomerically pure 1,1′-binaphth-2,2′-diyland M is iron.

21. A compound comprising a substantially enantiomerically pure compound defined in claim 18 in complex association with a Group VIII metal.

22. A compound as claimed in claim 21 wherein the Group VIII metal is ruthenium, iridium or rhodium.

23. A process for preparing a compound having formula 4 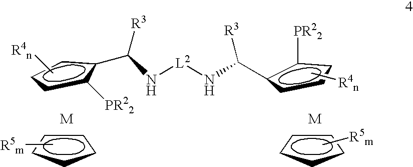
which comprises the steps of:
(1) contacting a dialkyl amine having formula 5: 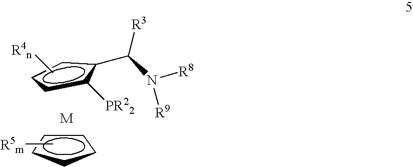
with a carboxylic anhydride having the formula (R¹⁰CO)₂O to obtain a first ester having formula 6: 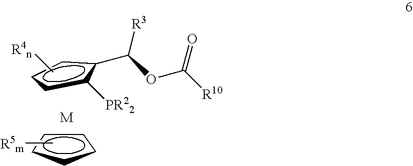
(2) contacting the ester produced in step (1) with a diamine having the formula H₂N-L²-NH₂ to obtain a phosphine-diamine 7 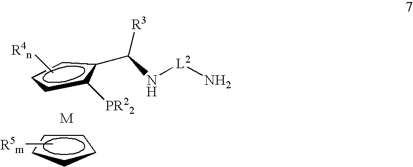
and (3) contacting the phosphine-diamine produced in step (2) with a second ester having formula 6 to afford diphosphine-diamine 4,
wherein each R² is independently a branched- or straight-chain C₁-C₂₀ alkyl, C₃-C₈ cycloalkyl, C₆-C₂₀ carbocyclic aryl, or a C₄-C₂₀ heteroaryl having from one to three heteroatoms selected from sulfur, nitrogen, or oxygen;
each R³, R⁴, and R⁵ is independently selected from hydrogen, branched- or straight-chain C₁-C₂₀ alkyl, C₃-C₈ cycloalkyl, C₆-C₂₀ carbocyclic aryl, or C₄-C₂₀ heteroaryl having from one to three heteroatoms selected from sulfur, nitrogen, and oxygen;
R⁸ and R⁹ are independently branched- or straight-chain C₁-C₂₀ alkyl, C₃-C₈ cycloalkyl, C₆-C₂₀ carbocyclic aryl, or C₄-C₂₀ heteroaryl having from one to three heteroatoms selected from sulfur, nitrogen, and oxygen;
each R¹⁰ is independently a C₁ to C₄ alkyl radical;
L² is an achiral, racemic, or enantiomerically enriched C₁-C₂₀ alkylene, C₃-C₈ cycloalkylene, or 1,1′-biaryl-2,2′-diyl;
n is 0 to 3;
m is 0 to 5; and
M is selected from the metals of Groups IVB, VB, VIB, VIIB and VIII.

24. A process according to claim 23, which further comprises the step of isolating phosphine-diamine 7 prior to step (3).

25. A process according to claim 24 wherein each R² is phenyl or 3,5-dimethylphenyl; each R³ is hydrogen or methyl; L² is 1,2-ethanediyl, 1,3-propanediyl, 1,4-butanediyl, substantially enantiomerically pure 1,2-diphenyl-1,2-ethanediyl, substantially enantiomerically pure trans-1,2-cyclohexanediyl, or substantially enantiomerically pure 1,1′-binaphth-2,2′-diyland M is iron.

26. A process according to claim 23 or 24 which further comprises the step of contacting the compound of formula 4 with a ruthenium metal precursor, a rhodium metal precursor or an iridium metal precursor.

27. A process according to claim 26 wherein the ratio of the compound of formula 4 to the metal of the metal precursor is about 0.8:1 to 1.5:1.

28. A process for preparing a compound having formula 8 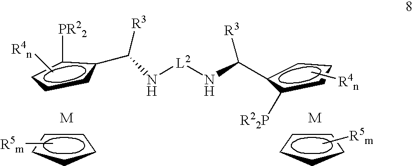
which comprises the steps of:
(1) contacting a dialkyl amine having formula 9: 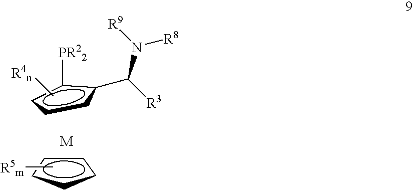
with a carboxylic anhydride having the formula (R¹⁰CO)₂O to obtain a first ester having formula 10: 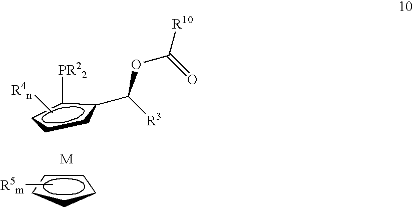
(2) contacting the ester produced in step (1) with a diamine having the formula H₂N-L²-NH₂ to obtain a phosphine-diamine 11 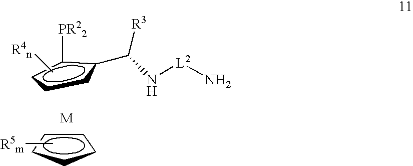
and (3) contacting the phosphine-diamine produced in step (2) with a second ester having formula 10 to afford diphosphine-diamine 8,
wherein each R² is independently a branched- or straight-chain C₁-C₂₀ alkyl, C₃-C₈ cycloalkyl, C₆-C₂₀ carbocyclic aryl, or a C₄-C₂₀ heteroaryl having from one to three heteroatoms selected from sulfur, nitrogen, or oxygen;
each R³, R⁴, and R⁵ is independently selected from hydrogen, branched- or straight-chain C₁-C₂₀ alkyl, C₃-C₈ cycloalkyl, C₆-C₂₀ carbocyclic aryl, or C₄-C₂₀ heteroaryl having from one to three heteroatoms selected from sulfur, nitrogen, and oxygen;
R⁸ and R⁹ are independently branched- or straight-chain C₁-C₂₀ alkyl, C₃-C₈ cycloalkyl, C₆-C₂₀ carbocyclic aryl, or C₄-C₂₀ heteroaryl having from one to three heteroatoms selected from sulfur, nitrogen, and oxygen;
each R¹⁰ is independently a C₁ to C₄ alkyl radical:
L² is an achiral, racemic, or enantiomerically enriched C₁-C₂₀ alkylene, C₃-C₈ cycloalkylene, or 1,1′-biaryl-2,2′-diyl;
n is 0 to 3;
m is 0 to 5; and
M is selected from the metals of Groups IVB, VB, VIB, VIIB and VIII.

29. A process according to claim 28 which further comprises the step of isolating the phosphine-diamine 11 prior to step (3).

30. A process according to claim 29 wherein each R² is phenyl or 3,5-dimethylphenyl; each R³ is hydrogen or methyl; L² is 1,2-ethanediyl, 1,3-propanediyl, 1,4-butanediyl, substantially enantiomerically pure 1,2-diphenyl-1,2-ethanediyl, substantially enantiomerically pure trans-1,2-cyclohexanediyl, or substantially enantiomerically pure 1,1′-binaphth-2,2′-diyland M is iron.

31. A process according to claim 28 or 29 which further comprises the step of contacting the compound of formula 8 with a ruthenium metal precursor, a rhodium metal precursor or an iridium metal precursor.

32. A process according to claim 31 wherein the ratio of the compound of formula 8 to the metal of the metal precursor is about 0.8:1 to 1.5:1.

33. A process for preparing a compound having formula 4 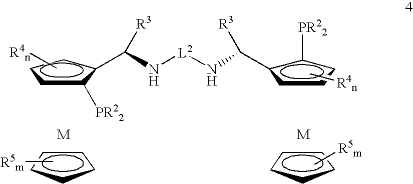
which comprises the steps of:
(1) contacting a dialkyl amine having formula 5: 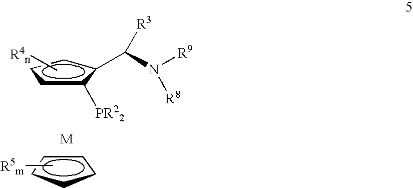
with a carboxylic anhydride having the formula (R¹⁰CO)₂O to obtain an ester having formula 6: 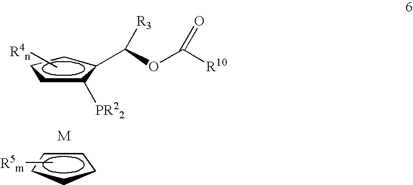
and (2) contacting the ester produced in step (1) with a diamine having the formula H₂N-L²-NH₂ to obtain diphosphine-diamine 4,
wherein R² is a branched- or straight-chain C₁-C₂₀ alkyl, C₃-C₈ cycloalkyl, C₆-C₂₀ carbocyclic aryl, or a C₄-C₂₀ heteroaryl having from one to three heteroatoms selected from sulfur, nitrogen, or oxygen;
R³, R⁴, and R⁵ are independently selected from hydrogen, branched- or straight-chain C₁-C₂₀ alkyl, C₃-C₈ cycloalkyl, C₆-C₂₀ carbocyclic aryl, or C₄-C₂₀ heteroaryl having from one to three heteroatoms selected from sulfur, nitrogen, and oxygen;
R⁸ and R⁹ are independently branched- or straight-chain C₁-C₂₀ alkyl, C₃-C₈ cycloalkyl, C₆-C₂₀ carbocyclic aryl, or C₄-C₂₀ heteroaryl having from one to three heteroatoms selected from sulfur, nitrogen, and oxygen;
R¹⁰ is a C₁ to C₄ alkyl radical:
L² is an achiral, racemic, enantiomerically enriched or substantially enantiomerically pure C₁-C₂₀ alkylene, C₃-C₈ cycloalkylene, or 1,1′-biaryl-2,2′-diyl;
n is 0 to 3;
m is 0 to 5; and
M is selected from the metals of Groups IVB, VB, VIB, VIIB and VIII.

34. A process according to claim 33 which further comprises the step of contacting the compound of formula 4 with a ruthenium metal precursor, a rhodium metal precursor or an iridium metal precursor.

35. A process according to claim 34 wherein the ratio of the compound of formula 4 to the metal of the metal precursor is about 0.8:1 to 1.5:1.

36. A process according to claim 34 wherein each R² is phenyl or 3,5-dimethylphenyl; each R³ is hydrogen or methyl; L² is 1,2-ethanediyl, 1,3-propanediyl, 1,4-butanediyl, substantially enantiomerically pure 1,2-diphenyl-1,2-ethanediyl, substantially enantiomerically pure trans-1,2-cyclohexanediyl, or substantially enantiomerically pure 1,1′-binaphth-2,2′-diyland M is iron

37. A process for preparing a compound having formula 8 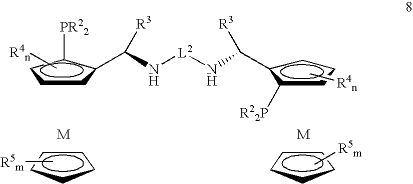
which comprises the steps of:
(1) contacting a dialkyl amine having formula 9: 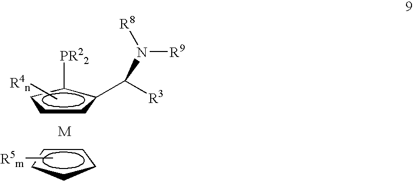
with a carboxylic anhydride having the formula (R¹⁰CO)₂O to obtain an ester having formula 10: 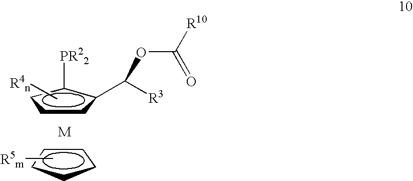
and (2) contacting the ester produced in step (1) with a diamine having the formula H₂N-L²-NH₂ to obtain diphosphine-diamine 8,
wherein R² is a branched- or straight-chain C₁-C₂₀ alkyl, C₃-C₈ cycloalkyl, C₆-C₂₀ carbocyclic aryl, or a C₄-C₂₀ heteroaryl having from one to three heteroatoms selected from sulfur, nitrogen, or oxygen;
R³, R⁴, and R⁵ are independently selected from hydrogen, branched- or straight-chain C₁-C₂₀ alkyl, C₃-C₈ cycloalkyl, C₆-C₂₀ carbocyclic aryl, or C₄-C₂₀ heteroaryl having from one to three heteroatoms selected from sulfur, nitrogen, and oxygen;
R⁸ and R⁹ are independently branched- or straight-chain C₁-C₂₀ alkyl, C₃-C₈ cycloalkyl, C₆-C₂₀ carbocyclic aryl, or C₄-C₂₀ heteroaryl having from one to three heteroatoms selected from sulfur, nitrogen, and oxygen;
R¹⁰ is a C₁ to C₄ alkyl radical:
L² is an achiral, racemic, enantiomerically enriched or substantially enantiomerically pure C₁-C₂₀ alkylene, C₃-C₈ cycloalkylene, or 1,1′-biaryl-2,2′-diyl;
n is 0 to 3;
m is 0 to 5; and
M is selected from the metals of Groups IVB, VB, VIB, VIIB and VIII.

38. A process according to claim 37 which further comprises the step of contacting the compound of formula 8 with a ruthenium metal precursor, a rhodium metal precursor or an iridium metal precursor.

39. A process according to claim 38 wherein the ratio of the compound of formula 8 to the metal of the metal precursor is about 0.8:1 to 1.5:1.

40. A process according to claim 38 wherein each R² is phenyl or 3,5-dimethylphenyl; each R³ is hydrogen or methyl; L² is 1,2-ethanediyl, 1,3-propanediyl, 1,4-butanediyl, substantially enantiomerically pure 1,2-diphenyl-1,2-ethanediyl, substantially enantiomerically pure trans-1,2-cyclohexanediyl, or substantially enantiomerically pure 1,1′-binaphth-2,2′-diyland M is iron.

41. A process which comprises contacting a dialkyl amine having formula 5: 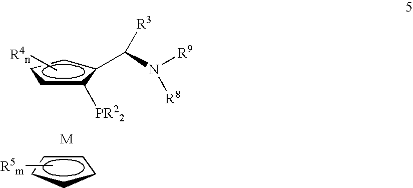
with a carboxylic anhydride having the formula (R¹⁰CO)₂O to obtain an ester having formula 6: 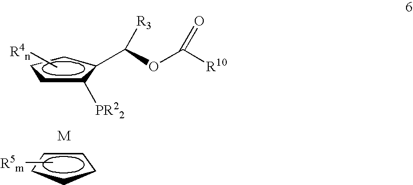
and contacting the ester 6 with a diamine having the formula H₂N-L²-NH₂ to obtain a phosphine-diamine 7 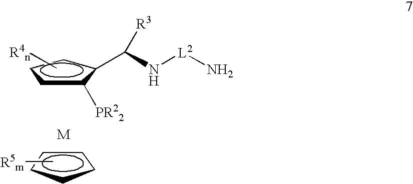
wherein R² is a branched- or straight-chain C₁-C₂₀ alkyl, C₃-C₈ cycloalkyl, C₆-C₂₀ carbocyclic aryl, or a C₄-C₂₀ heteroaryl having from one to three heteroatoms selected from sulfur, nitrogen, or oxygen;
R³, R⁴, and R⁵ are independently selected from hydrogen, branched- or straight-chain C₁-C₂₀ alkyl, C₃-C₈ cycloalkyl, C₆-C₂₀ carbocyclic aryl, or C₄-C₂₀ heteroaryl having from one to three heteroatoms selected from sulfur, nitrogen, and oxygen;
R⁸ and R⁹ are independently branched- or straight-chain C₁-C₂₀ alkyl, C₃-C₈ cycloalkyl, C₆-C₂₀ carbocyclic aryl, or C₄-C₂₀ heteroaryl having from one to three heteroatoms selected from sulfur, nitrogen, and oxygen;
R¹⁰ is a C₁ to C₄ alkyl radical:
L² is an achiral, racemic, enantiomerically enriched or substantially enantiomerically pure C₁-C₂₀ alkylene, C₃-C₈ cycloalkylene, or 1,1′-biaryl-2,2′-diyl;
n is 0 to 3;
m is 0 to 5; and
M is selected from the metals of Groups IVB, VB, VIB, VIIB and VIII.

42. A process according to claim 41 wherein R² is aryl; R³ is hydrogen or C₁ to C₆ alkyl; R⁴ and R⁵ are hydrogen, L² is 1,2-ethanediyl, 1,3-propanediyl, 1,4-butanediyl, substantially enantiomerically pure 1,2-diphenyl-1,2-ethanediyl, substantially enantiomerically pure trans-1,2-cyclohexanediyl, or substantially enantiomerically pure 1,1′-binaphth-2,2′-diyl, and M is iron.

43. A process which comprises contacting a dialkyl amine having formula 9 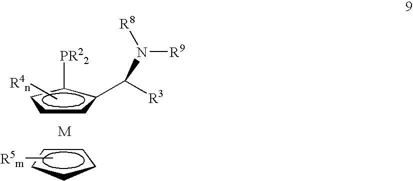
with a carboxylic anhydride having the formula (R¹⁰CO)₂O to obtain an ester having formula 10 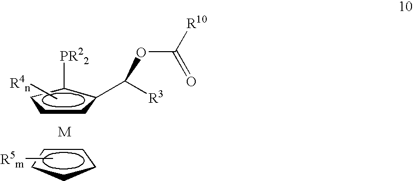
and contacting ester 10 with a diamine having the formula H₂N-L²-NH₂ to obtain a phosphine-diamine 11 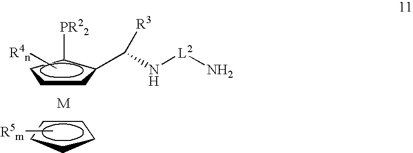
wherein R² is a branched- or straight-chain C₁-C₂₀ alkyl, C₃-C₈ cycloalkyl, C₆-C₂₀ carbocyclic aryl, or a C₄-C₂₀ heteroaryl having from one to three heteroatoms selected from sulfur, nitrogen, or oxygen;
R³, R⁴, and R⁵ are independently selected from hydrogen, branched- or straight-chain C₁-C₂₀ alkyl, C₃-C₈ cycloalkyl, C₆-C₂₀ carbocyclic aryl, or C₄-C₂₀ heteroaryl having from one to three heteroatoms selected from sulfur, nitrogen, and oxygen;
R⁸ and R⁹ are independently branched- or straight-chain C₁-C₂₀ alkyl, C₃-C₈ cycloalkyl, C₆-C₂₀ carbocyclic aryl, or C₄-C₂₀ heteroaryl having from one to three heteroatoms selected from sulfur, nitrogen, and oxygen;
R¹⁰ is a C₁ to C₄ alkyl radical:
L² is an achiral, racemic, enantiomerically enriched or substantially enantiomerically pure C₁-C₂₀ alkylene, C₃-C₈ cycloalkylene, or 1,1′-biaryl-2,2′-diyl;
n is 0 to 3;
m is 0 to 5; and
M is selected from the metals of Groups IVB, VB, VIB, VIIB and VIII.

44. A process according to claim 43 wherein R² is aryl; R³ is hydrogen or C₁ to C₆ alkyl; R⁴ and R⁵ are hydrogen, L² is 1,2-ethanediyl, 1,3-propanediyl, 1,4-butanediyl, substantially enantiomerically pure 1,2-diphenyl1,2-ethanediyl, substantially enantiomerically pure trans-1,2-cyclohexanediyl, or substantially enantiomerically pure 1,1′-binaphth-2,2′-diyl, and M is iron.

45. A process for the enantioselective hydrogenation of a hydrogenatable compound which comprises contacting the hydrogenatable compound with hydrogen in the presence of a catalyst complex defined in claim 8, 16 or 21.

46. A process acccording to claim 45 wherein the hydrogenatable compound is a non-symmetrical ketone such that the product of the process is a chiral secondary alcohol.

47. A process according to claim 46 wherein the enantioselective hydrogenation is carried out in the presence of a Bronsted base chosen from metal hydroxides or metal alkoxides.

48. A process according to claim 47 wherein the Bronsted base is sodium hydroxide, potassium hydroxide, sodium methoxide, potassium methoxide, sodium tert-butoxide, or potassium tert-butoxide.

49. A process for the enantioselective hydrogenation of a hydrogenatable compound which comprises contacting the hydrogenatable compound with hydrogen in the presence of a complex of a compound of formula 1 as set forth in claim 1 and a ruthenium metal precursor, a rhodium metal precursor or an iridium metal precursor.

50. A process acccording to claim 49 wherein the hydrogenatable compound is a non-symmetrical ketone such that the product of the process is a chiral secondary alcohol.

51. A process according to claim 50 wherein the enantioselective hydrogenation is carried out in the presence of a Bronsted base chosen from metal hydroxides or metal alkoxides.

52. A process according to claim 51 wherein the Bronsted base is sodium hydroxide, potassium hydroxide, sodium methoxide, potassium methoxide, sodium tert-butoxide, or potassium tert-butoxide.
